(19) United States
(12) Patent Application Publication
(10) Pub. No.: US 2016/0200335 A1
(43) Pub. Date: Jul. 14, 2016

(54) WHEELED CART

(71) Applicant: The Real Wheel, LLC, Lexington, MA (US)

(72) Inventors: Jacqueline Piscitello, Lexington, MA (US); Yavor Gegov, Haskovo (BG)

(21) Appl. No.: 15/078,955

(22) Filed: Mar. 23, 2016

Related U.S. Application Data
(63) Continuation-in-part of application No. 14/879,069, filed on Oct. 8, 2015.
Application No. 14/879,069 is a continuation-in-part of application No. 14/019,955, filed on Sep. 6, 2013, now Pat. No. 9,227,644.

(51) Int. Cl. B62B 1/10; B60F 3/00; A61G 1/02; B60C 5/20; B62B 5/06; B60C 23/10; B60C 29/00; B63H 16/06; B62B 5/00

(52) U.S. Cl. CPC B62B 1/10; B63H 16/06; B60F 3/0038; A61G 1/02; B62B 5/0013; B62B 5/067; B62B 5/0036; B60C 23/10; B60C 29/002; B60C 5/20

(57) ABSTRACT

A rolling cart comprises a frame unit defining an interior space in which items are transportable; a tire, the tire having a boundary defined by a circumference, a left edge maximum extent, and a right edge maximum extent, a distance between the left edge maximum extent and the right edge maximum extent sufficient to provide the cart with inherent lateral stability; a handle supported optionally removably from the frame, the cart moved and controlled by the handle; and the interior space at least partly within the boundary. The rolling cart may further comprise a container in which the items are transportable suspended within the interior space. The tire may include several segments, which may or may not be inflatable with distributions system for an inflation fluid including a bi-directional pump and valves.

### BACKGROUND

The present invention relates generally to wheeled carts. More particularly, the invention relates to carts for transporting goods, material, liquids, gases, and people over a wide range of terrain types, including rough, rocky, sandy, muddy, rutted, paved, water-, ice-, and snow-covered terrain and surfaces, uneven terrain and surfaces, and stairs.

### SUMMARY

The invention is realized in embodiments that include a pneumatic, segmented pneumatic, mechanically articulated, or other conformable tire. The cart has a large inner diameter so as to accommodate a storage container within a frame from which the tire is rotatably suspended. The width of the ground-contact region of the cart can be as wide as the container, so as to maintain the center of gravity between the edges of the ground-contact region of the tire. The contact region of the tire can be somewhat narrower, provided the center of gravity is still controlled to remain between the edges of the ground-contact region, so as to maintain stability. Handles attach to the frame or the container on each side of the tire. A sheet of canvas, rigid litter, or the like can be suspended between the handles to form a medical stretcher or litter for transporting equipment or an injured or exhausted member of a party performing work, sport, or the like, in the field. Attachment points, pins, ratchets, clamps, brackets, and the like can be used to attach a separate medical stretcher or litter to, or aligned with, the handles or any other convenient position in which the weight of a stretcher or litter and its contents can be supported at least in part by the cart and maneuvered by one or more operators. The handles can be detachable and optionally foldable for storage within the cargo container, and with attachments can serve other purposes, such as forming a stand for support, oars for use with a buoyant embodiment of the wheel, which when floating on a water surface can be used as a rowboat. Other attachment points, attachments, clamps, brackets, and the like can provide additional leg supports, including those that swing down from the handles or other attachment points, support bags, other odd-shaped objects, and other accessories of suitable size, weight, and configuration to be carried. Another attachment can be a detachable and foldable tabletop that can be stored within the cargo container.

The invention is illustrated by numerous embodiments, the features of which may be combined in additional ways as will be evident upon reading the following exposition of some of the embodiments.

According to aspects of embodiments of the invention, a rolling cart comprises: a frame unit defining an interior space in which items are transportable; a tire, the tire having a boundary defined by a circumference, a left edge maximum extent, and a right edge maximum extent, a distance between the left edge maximum extent and the right edge maximum extent sufficient to provide the cart with inherent lateral stability; a handle supported, optionally removably, from the frame, the cart moved and controlled by the handle; and the interior space at least partly within the boundary.

According to variations of aspects of embodiments of the invention, the rolling cart further comprises: a container in which the items are transportable suspended within the interior space, such that the tire rotates about the container without any corresponding rotation of the container. The container may be integral to the frame unit. The rolling cart may include a first plurality of rollers rotatably connected to the frame unit; and a first inner surface defined by the wheel, the first inner surface contacting the first plurality of rollers for rotatable support. That is, there may be as few as one plurality of rollers supporting the frame unit from the wheel. The rolling cart may further comprise at least a second plurality of rollers rotatably connected to the frame unit; and a second inner surface defined by the wheel, the second inner surface contacting the second plurality of rollers for rotatable support. The cart may further comprise a pole mount which can support the handle from the frame unit in a position substantially perpendicular to a plane in which the circumference lies; and a shade fabric extensible from the handle; whereby the handle, when supported by the pole mount, can support the shade fabric above a ground surface, and the shade fabric provides a sheltered area beneath the wheel when extended.

In yet another embodiment, the rolling cart may further comprise: an oarlock mount which can support the handle from the frame unit when the wheel lies in a position such that a plane in which the circumference lies is roughly parallel to a plane in which a water surface lies; and a paddle end fitted to a distal end of the handle when the handle is supported by the oarlock mount; wherein the cart possesses sufficient buoyancy to float along with the transportable items and/or a passenger. The cart can also be floated along upright in shallow water, guided by the operator using the handles in their normal configuration. In a variation on this embodiment, the tire substantially provides the sufficient buoyancy.

In other alternative embodiments of the rolling cart, there may be provided a handle extension forward of the cart and a handle extension aft of the cart, whereby the cart can be maneuvered by two handlers, one fore and one aft. In another alternative embodiment, there may be provided a shoulder harness, whereby the cart can be hauled using shoulder contact to transfer force from a handler to the cart.

In some embodiments, the rolling cart further comprises a flexible sheet or rigid stretcher suspended from the handle and configured and arranged to carry a non-ambulatory person or object. In other embodiments, the handle further comprises a medical stretcher support having hold-down points for securing a medical stretcher thereto.

According to yet other variations of embodiments, the tire further comprises: an inflatable segment arranged within the circumference to support the cart. In a variation usable in conjunction with a pump, the tire further comprises: plural inflatable segments arranged within the circumference to support the cart; an inflation fluid manifold constructed and arranged to communicate with the pump for communicating inflation fluid with the inflation fluid manifold; plural bi-directional valves corresponding to the plural inflatable segments communicating inflation fluid between the inflation fluid manifold and the plural inflatable segments; the plural bi-directional valves constructed and arranged to substantially freely admit the inflation fluid from the manifold into an inflatable segment at a manifold pressure higher than a segment pressure, and to exhaust inflation fluid from the inflatable segment into the manifold only at a segment pressure higher than a manifold pressure by at least an increment provided by a combination of a load of the cart and action of the bi-directional pump communicating inflation fluid out of the inflation fluid manifold. The plural bi-directional valves may be reed valves further comprising: a valve body having a passage defined through the valve body between the inflation fluid manifold and the inflatable segment, the passage having an edge; a reed affixed to the edge of the passage, having one surface toward the inflation fluid manifold and another surface toward the inflatable segment, and bendable toward the inflation fluid manifold or the inflatable segment through the passage; and a spring disposed substantially adjacent to one surface of the reed such that a higher pressure is required to bend the reed toward the inflation fluid manifold than toward the inflatable segment. Alternatively, in the cart usable in conjunction with a pump, the tire further comprises: plural inflatable segments arranged within the circumference to support the cart. Such a rolling cart may further comprise: an inflation fluid manifold constructed and arranged to communicate with the pump for communicating inflation fluid with the inflation fluid manifold; plural bi-directional valves corresponding to the plural inflatable segments manually selectable to communicate inflation fluid between the inflation fluid manifold and each one or more of the plural inflatable segments.

According to yet another embodiment of the invention, a wheeled cart comprises: a central cargo container; a handle attached to the central cargo container; and only one tire, circumferentially disposed about the central cargo container, from which the central cargo container is suspended; wherein the one tire has a width sufficient to keep a center of gravity of the cart between edges of a ground contact region of the tire. This cart may further comprise: articulated sections with locking joints forming the handle, the articulated joints configurable to at least a moving position and a stand position, wherein the cart is stable without an operator holding it in place when the articulated joints are configured to the stand position. The handle of this cart may yet further comprise a frame to which a platform can be clamped or otherwise attached; and at least one articulated joint comprising a fold-up stand section.

### DESCRIPTION OF THE DRAWINGS

In the following description, reference is made to the accompanying drawings, which form a part hereof, and in which are shown example implementations. It should understood that other implementations are possible, and that these example implementations are intended to be merely illustrative.

FIG. 1 is an isometric view of an embodiment of the invention.

FIG. 2 is a side view of the embodiment of FIG. 1.

FIG. 3 is a top view of the embodiment of FIG. 1.

FIG. 4 is a perspective view of the embodiment of FIG. 1 in use as a medical stretcher in the field.

FIG. 5 is an isometric view of an alternate embodiment of the invention.

FIG. 5a is an isometric view of a further alternate embodiment of the invention.

FIG. 6 is an isometric view of another alternate embodiment of the invention.

FIG. 7 is a detail showing the wheel, container, and handle construction of embodiments of FIGS. 1-5.

FIG. 8 is an exploded view of the embodiments of FIGS. 1-5.

FIG. 9 is a front view of the wheel of the embodiments of FIGS. 1-8.

FIG. 10 is an isometric view of the wheel of FIG. 9.

FIG. 11 is an isometric view of the container of embodiments of the invention.

FIG. 12 is an isometric view of a cage that supports the wheel of various embodiments of the invention.

FIG. 13 is an exploded view of the cage of FIG. 12.

FIG. 14 is an isometric view of an embodiment of the invention in use as a boat with oars.

FIG. 15 is an isometric view of a tire incorporating a manual valve arrangement for inflating inflatable tire segments.

FIG. 16 is a detail view of a valve of the tire of FIG. 15.

FIG. 17 is an isometric view of an alternative manifold and valve arrangement for inflating inflatable tire segments.

FIG. 18 is an isometric view of a reed valve in a closed position from the alternative arrangement of FIG. 17.

FIG. 19 is an isometric view of the reed valve in an open position from the alternative arrangement of FIG. 17.

FIG. 20 is a cutaway side view of the reed valve of FIG. 19 in an open position.

FIG. 21 is a cutaway side view of the reed valve of FIG. 18 in a closed position.

FIG. 22 is a side cutaway view of the valve and manifold arrangement of FIG. 17 assembled to an inflatable tire having plural inflatable tire segments.

FIG. 23 is an isometric view of the cart as a disassembled kit.

FIG. 24 is a sequential illustration of the assembly steps for transforming the kit of FIG. 23 to a cart of the exemplary embodiment of FIG. 1.

FIG. 25 is an isometric view of the assembly of FIG. 24, prior to Step A.

FIG. 26 is an isometric view of the assembly of FIG. 24, after Step A.

FIG. 27 is an isometric view of the assembly of FIG. 24, after Step B.

FIG. 28 is an isometric view of the assembly of FIG. 24, after Step C.

FIG. 29 is an isometric view of the assembly of FIG. 24, after Step D.

FIG. 30 is an isometric view of the assembly of FIG. 24, after Step E.

FIG. 31 is an isometric view of the assembly of FIG. 24, after Step F.

FIG. 32 is an isometric view of the assembly of FIG. 24, after Step G.

FIG. 33 is an isometric view of the assembly of FIG. 24, after Step H.

FIG. 34 is an isometric view of a handle assembly held together with shock cord.

FIG. 35 is an isometric view of a cart having a single chamber, or a covering over plural chambers, so as to present a more uniform surface.

FIG. 36 is an isometric view of another embodiment of a cart having a foldable handle and carrying platform in an open position.

FIG. 36A is a detail of an alternate embodiment of a cart with a foldable handle and adjustable hold-downs for a carrying platform or other articles.

FIG. 37 is an isometric view of the cart of FIG. 36 with the foldable handle folded into a stand for stabilizing the cart when not in motion.

FIG. 38 is an exploded view of the cart of FIG. 36.

FIG. 39 is a front view of the cart of FIG. 36.

FIG. 40 is a side view of the cart of FIG. 36.

FIG. 41 is a top view of the cart of FIG. 36.

FIG. 42 is a side section taken through plane A-A of the cart of FIG. 36.

FIG. 43 is an isometric view of a variation of the cart of FIG. 36 including a foldable handle with attachment for carrying a stretcher or other elongated platform.

FIG. 43A is a detail of a lever lock hold-down for securing a stretcher to any of the carts shown.

FIG. 44 is an isometric view of a variation of the cart having swing-down legs and an alternative hold-down mechanism.

FIG. 45 is a side view with a cross-section of the wheel and frame showing the roller structure.

FIG. 46 is a detail view showing the rigid tabletop and handle structures.

FIG. 47 is a detail showing the attachment of the tabletop to the frame and a cross-section of the wheel and frame showing the thrust bearings.

FIG. 48 is a front cross-section view of the cart showing the rollers, ball caster thrust bearings, and tabletop.

FIG. 49 is a detail of the front cross-section view of FIG. 48.

FIG. 50 is a perspective view of another embodiment of the cart.

FIG. 51 is a detail of the brake system of FIG. 50.

FIG. 52 is a perspective view of yet another embodiment of the cart.

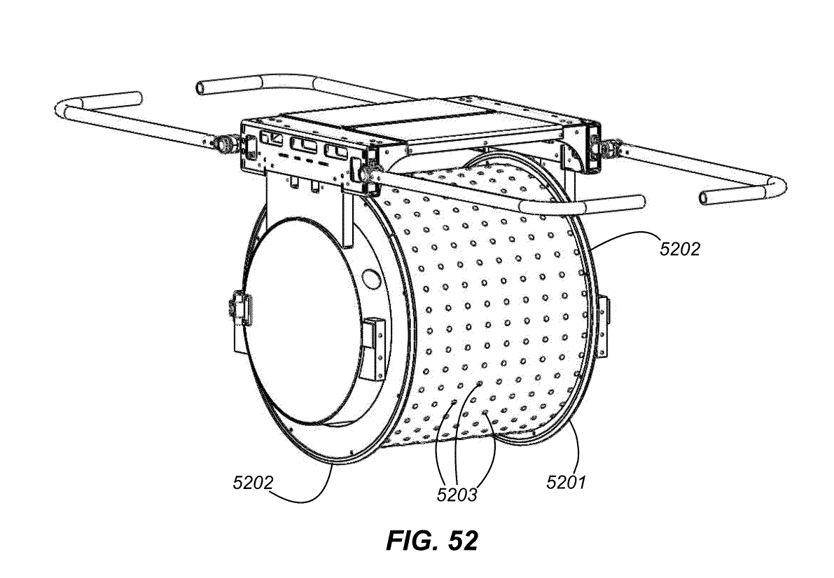

FIG. 53 is a side view showing an alternate embodiment of a suspension for a cart including a handle and tabletop assembly.

FIG. 54 is a perspective view of the suspension system of the embodiment of FIG. 53.

FIG. 55 is an end view showing the suspension system of FIG. 54 under an offset compressive load.

FIG. 56 is an end view of the embodiment of FIG. 53 showing the effect of an offset compressive load on the suspension.

FIG. 57 is an end view of the embodiment of FIG. 53 showing the suspension at rest.

FIG. 58 is a side view of the embodiment of FIG. 53 showing the effect of an offset compressive load on the suspension.

### DETAILED DESCRIPTION

The following section provides a general and detailed description of some embodiments and alternatives of the invention. Reference is made to the FIGs., which illustrate various aspects of embodiments of the invention.

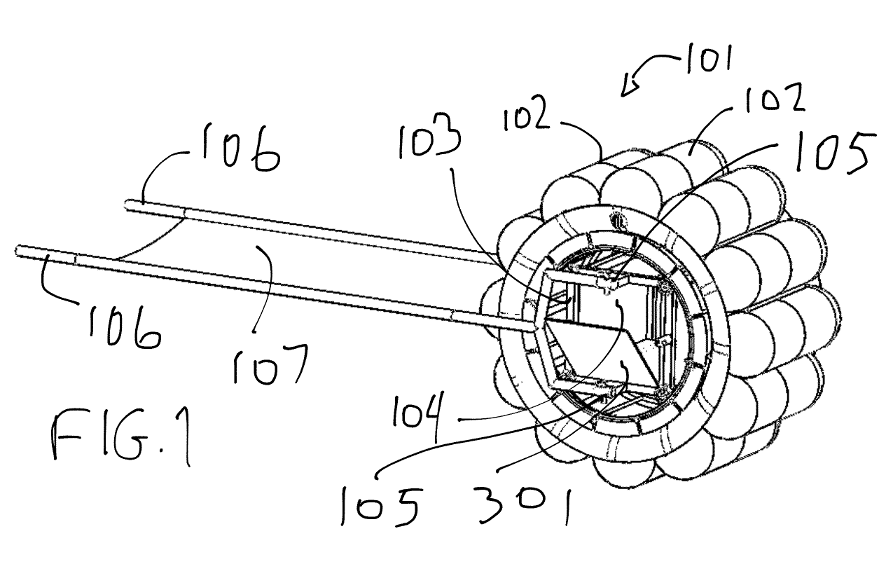

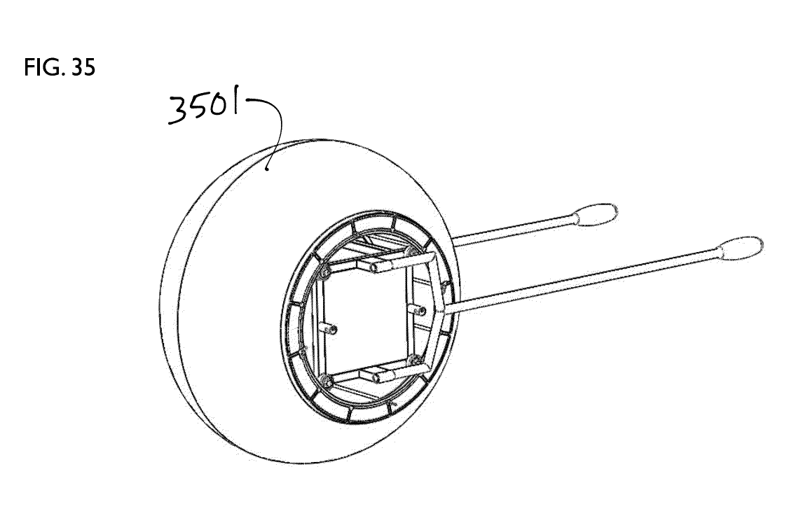

Referring to FIG. 1, a first embodiment is now described to illustrate examples of some elements and aspects of the invention. This embodiment includes a wheel, 101, including a tire having plural, inflatable tread elements, 102. The tread elements, 102, may be independent chambers, each inflated separately with an inflation fluid such as air, nitrogen, water or any other suitable fluid, or may collectively form one or more larger chambers due to communication of the inflation fluid between them via tubes or holes in a common wall. Alternatively, the tread elements may simply be one or more suitable natural or artificial materials such as polymer, monomer, elastomer, gel, natural or artificial rubber, woven or non-woven fabric, etc., formed into rigid, semi-rigid, closed-cell foam, or open-celled foam, skinned foam, etc. depending on what demands may be put on the cart in use. Specific materials may impart particular advantages or characteristics for which those materials are known. The tire may include different types of covers with different materials, or a cover of any type of desired material may be attached to the wheel or tire, covering the tire by connecting such cover to attachment points on the wheel or tire. In two additional variations, shown in FIG. 35, a wheel, 3501, can have a single chamber, or a covering over plural chambers, so as to present a more uniform surface. The wheel, 101, is rotationally connected to a frame, 103. The interior of the frame, 103, houses a container, 104, within which articles the user desires to carry can be secured. The container, 104, may have a latching or locking door, 301, for example, to secure the articles carried within the container, 104. The frame further includes mounting brackets, 105, lateral to the wheel, 101, which receive laterally disposed handles, 106, by which the cart can be pushed or pulled over or through the terrain in which the user is using the cart. The handles, 106, may be further connected and stabilized by the addition of bracing (not shown), and a canvas sheet, 107, or the like may connect the handles, 106, to form a medical stretcher or litter for carrying an injured or tired person, or for carrying equipment, through the field. Alternative embodiments have the handles, 106, attached directly to the frame, 103, rather than through mounting brackets, 105. Any suitable connector, preferably removable and replaceable in the field, can be used to attach the handles to the mounting brackets or frame, such as a socket, a socket with a detent, a socket with a cotter pin retainer, a bolt, threads on the end of the handles, 106, and the like.

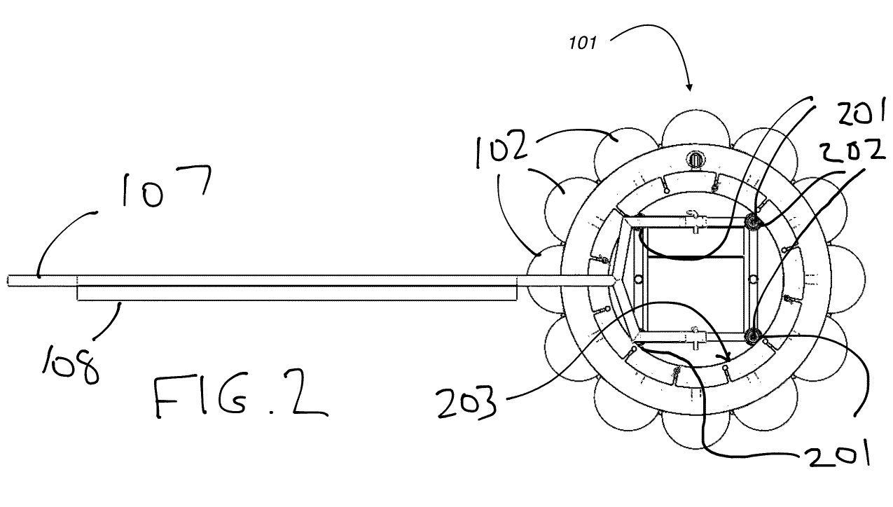

In the side view of FIG. 2, some additional details of the embodiments described in connection with FIG. 1 are seen. Rotational connection of the wheel, 101, to the frame, 103, can be seen to be achieved by small wheels, 201, each rotationally affixed to the frame, 103, at discrete points where small axels, 202, are connected to the frame, 103. The small wheels, 201, are located towards both lateral sides of the wheel, 101, where they ride in tracks, 203, affixed to the wheel, 101. Thus, the forces due to the mass of the frame, 103, container, 104, and any contents of the container, 104, pushing or pulling of the handles, 106, etc. are transmitted to the wheel, 101, through the axels, 202, the small wheels, 201, and the tracks, 203, to cause the wheel, 101, to support the same and permit movement over the terrain. In some variations, as further explained below, long rollers having a width up to the width between the left and right sides of the frame, 103, may be used rather than small wheels, 201, located towards the lateral sides of the wheel, 101.

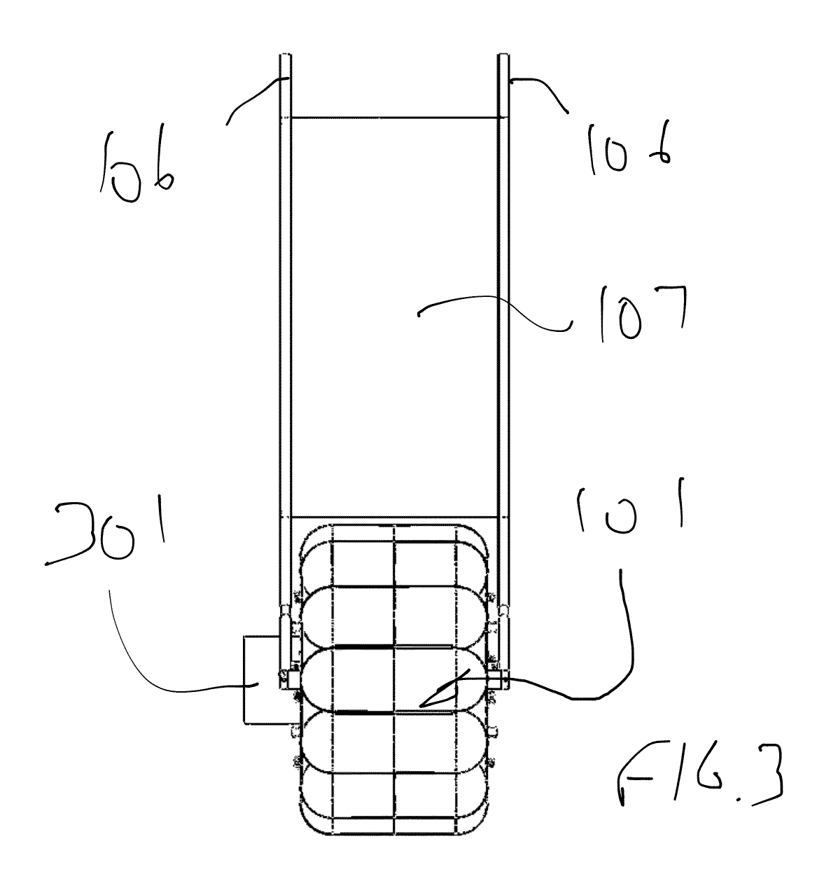

FIG. 3 additionally shows a door, 301, to container, 104, in a partially open position.

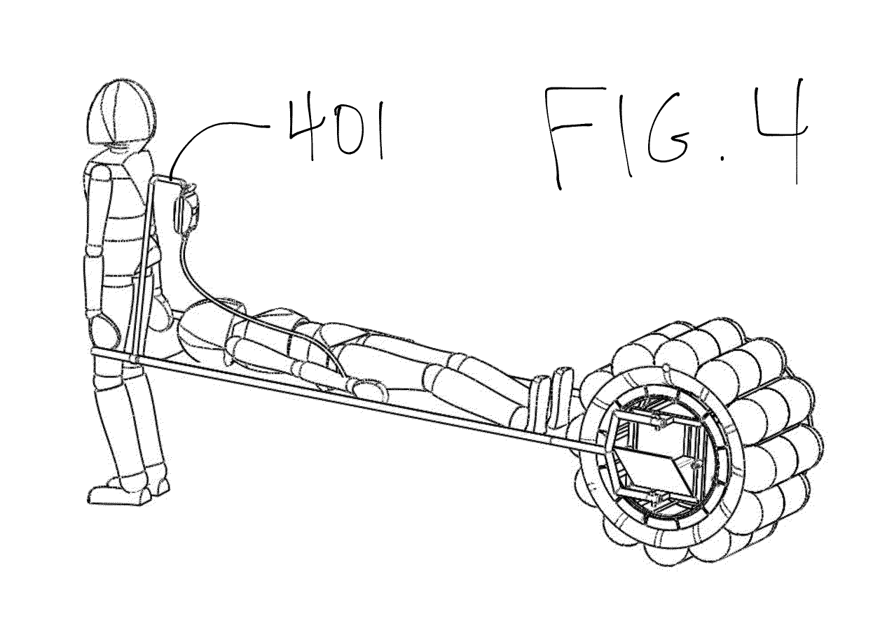

FIG. 4 shows the configuration just described, in use as a medical litter. Supplies can be carried in the container, 104, and deployed such as the IV pole, 401, as needed. The IV pole or the like, 401, clamps onto a handle at any convenient location.

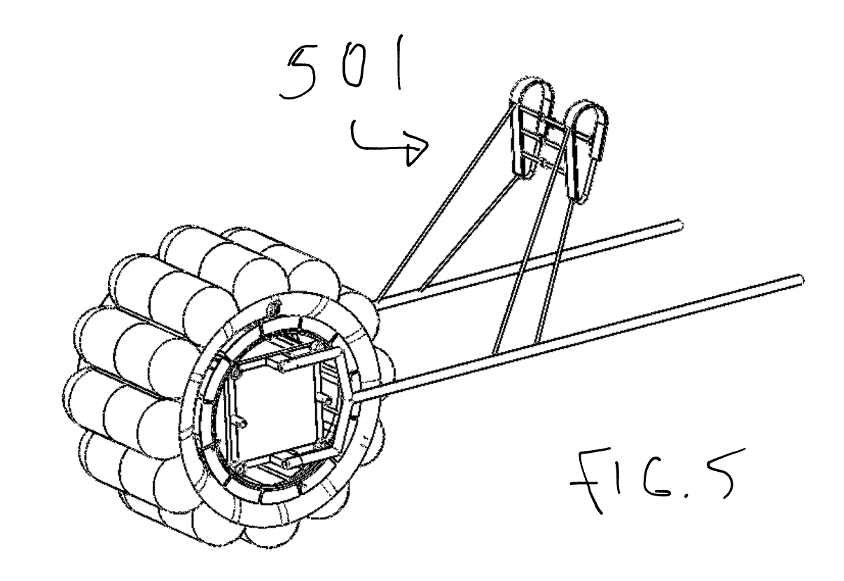

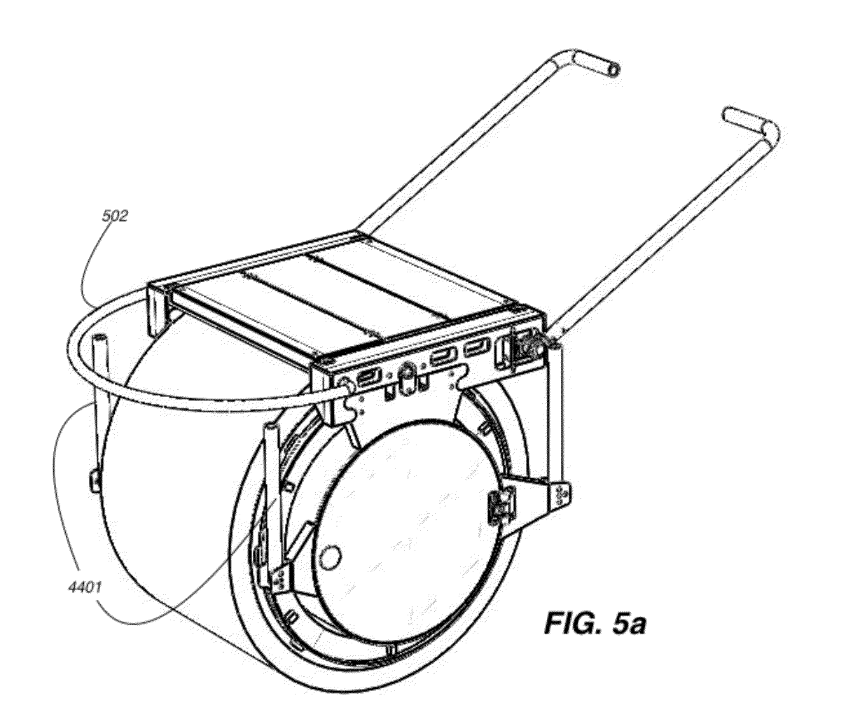

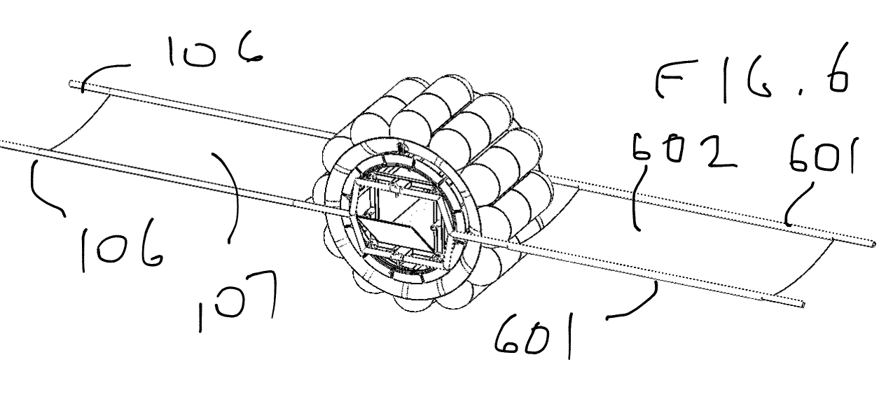

FIGS. 5 and 6 illustrate some variations of the above-described embodiments that enable the invention to carry greater loads over rougher terrain or up hills or stairs. In FIG. 5, straps are added to form a harness, 501, for an operator to distribute the lifting or hauling load to the operator's shoulders, similar to the way a backpack is worn. The harness may be rigidly attached to the handles, 106, or may be formed entirely of webbing, flexible line, or the like, or may be a combination of fixed and flexible materials. In FIG. 6, a second set of handles, 601, is added, along with a canvas, 602, to form a second medical litter. Thus, in the variation shown in FIG. 6, two operators can move a load nearly twice as large or over far more challenging terrain as a single operator can. The capacity of this embodiment or challenge of the terrain over which it is used can be further increased by combining the two handles of FIG. 6 with the harness of FIG. 5, or even with a loop of rope, 502, affixed to attachment points on the front of the cart as shown in FIG. 5a.

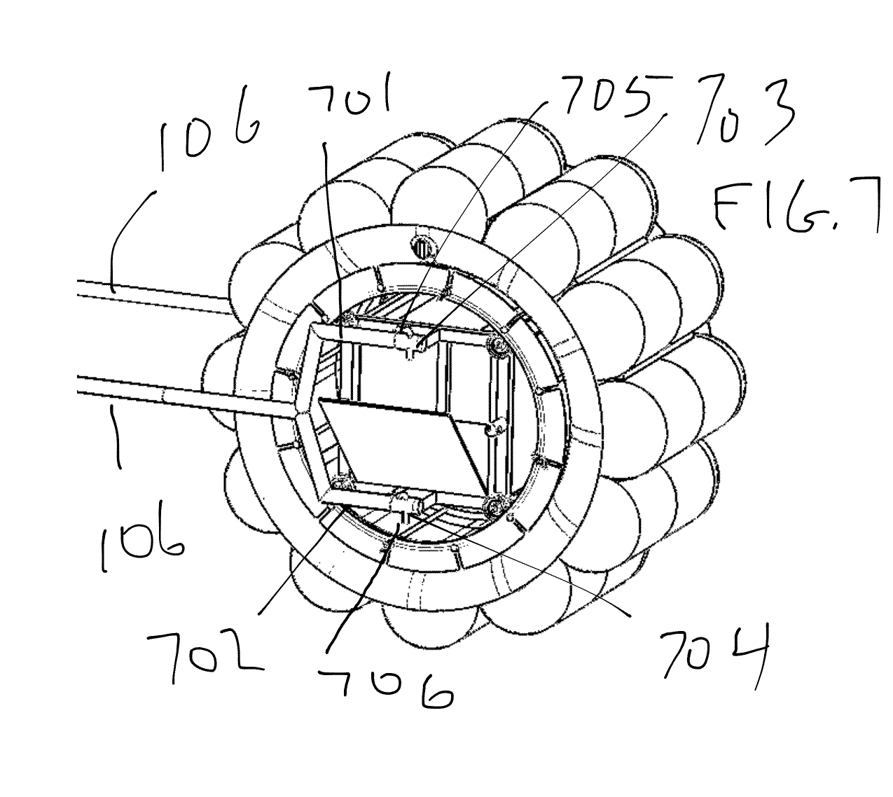

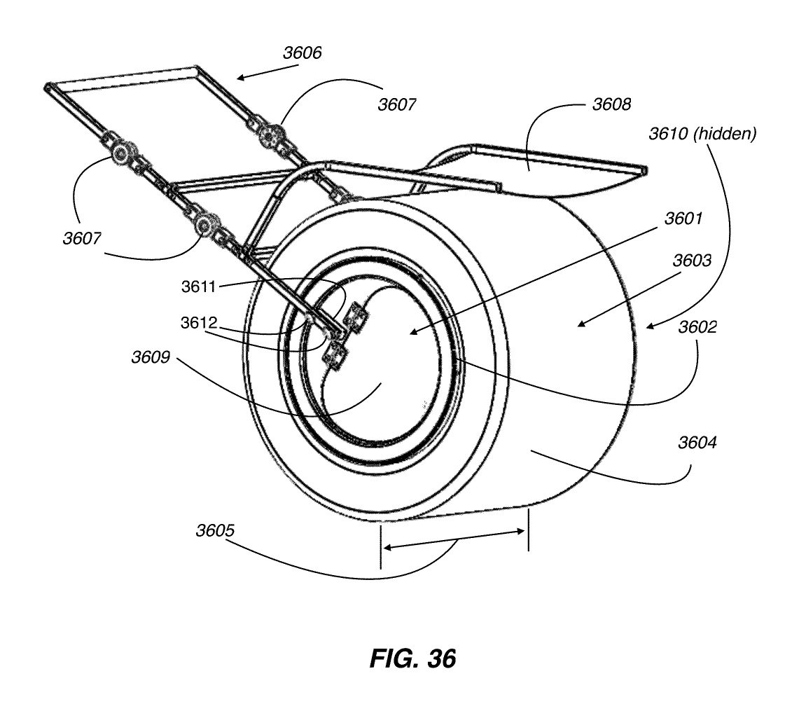

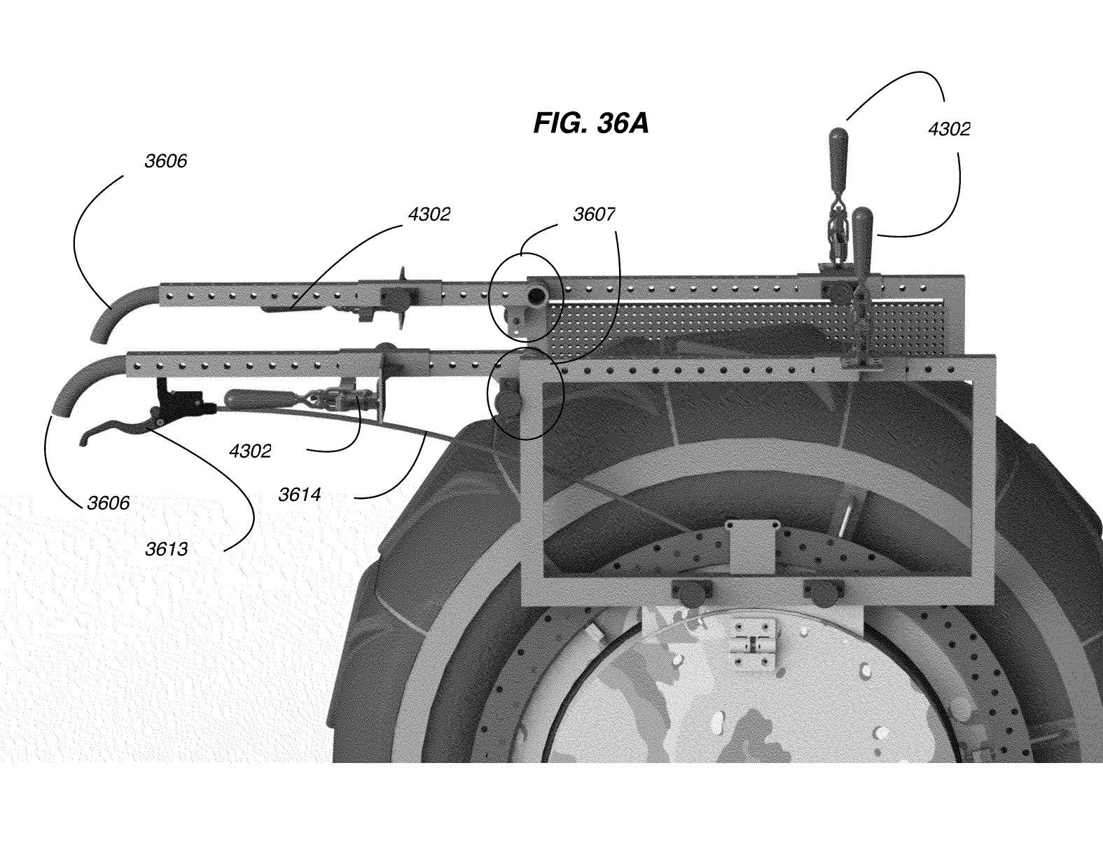

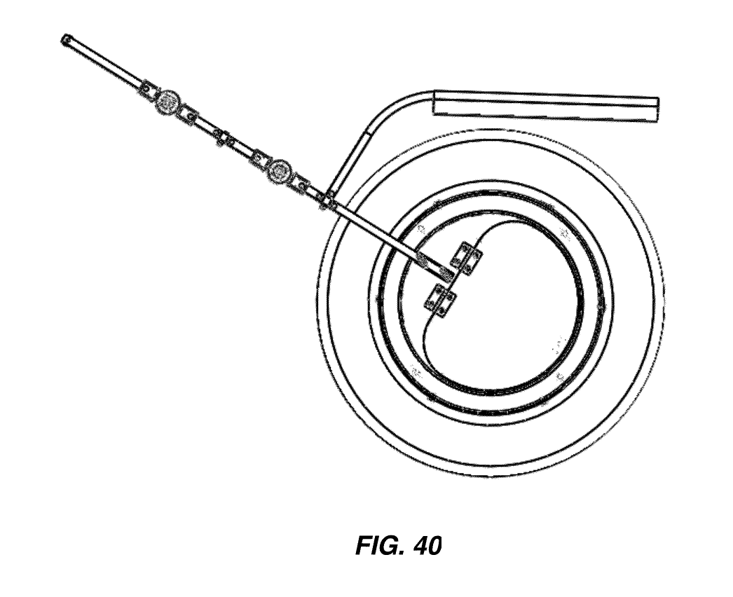

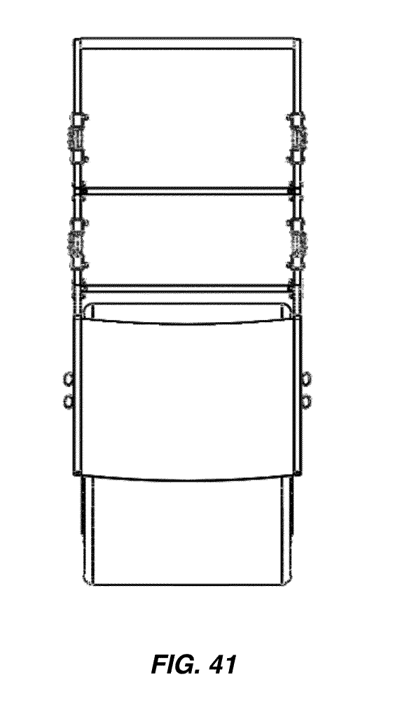

FIG. 7 shows the details of the handle attachment to the frame. Each handle, 106, has a bifurcated end, 701 and 702, which insert into two sockets, 703 and 704. The bifurcated ends, 701 and 702, are held in the sockets, 703 and 704, by clevis pins, 705 and 706, that drop in from above. With that arrangement, clevis pins, 705 and 706, may require no further securing, as they may be held in place by gravity; however, they may be arranged to enter from a different angle, or may require securing due to the intended use of the cart. In such an instance, clevis pins, 705 and 706, may include a ball detent, a cotter pin hole, or other retention device as may be desired. An example of another retention device (shown in FIGS. 36-42) is a block (FIGS. 36 and 42, 3611) affixed to or part of the frame, 103, or affixed to or part of the central cargo container (FIG. 36, 3601). This exemplary retention device is held together with the handle (FIG. 36, 3606) by thumbscrews (FIGS. 36 and 42, 3612). The foregoing embodiments can be combined, as well, such that the blocks, 3611, are held to the structure (frame, 103; or, central cargo container, 3601) by thumbscrews or other suitable fasteners, while the handle is pinned to the blocks, 3611, using clevis pins, 705 and 706, thumbscrews, or other suitable fasteners.

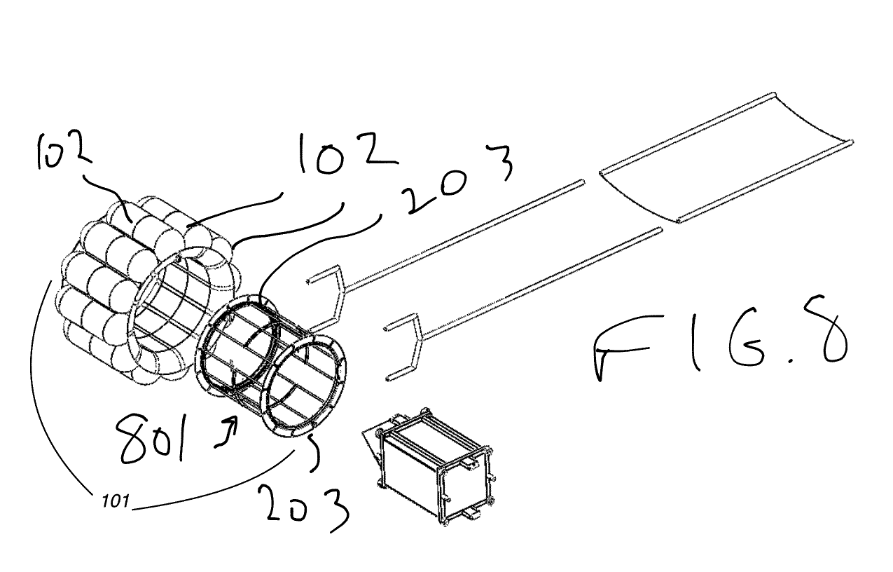

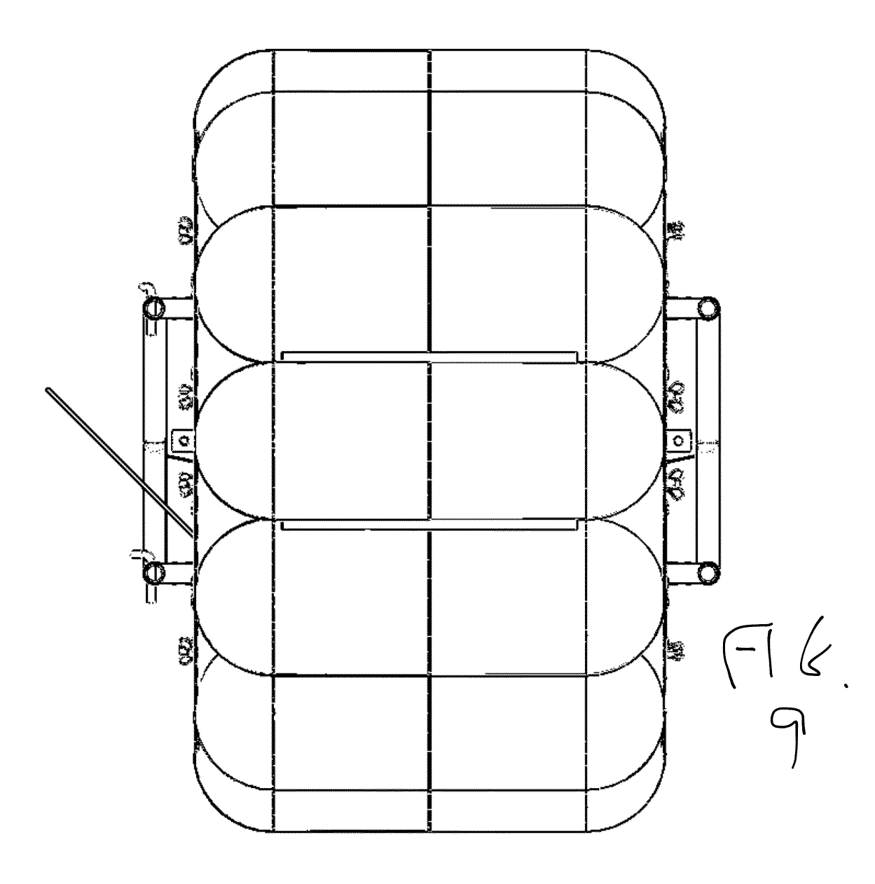

FIGS. 8 and 9 show how the components go together. Wheel, 101, comprises the separate tread elements, 102, bonded, formed, or otherwise joined into a single tire which together with the cage, 801, forms wheel, 101. Cage, 801, holds tracks, 203, within and at the edges of wheel, 101, where small wheels, 201, rotationally support frame, 103, to wheel, 101. In an alternative embodiment, frame, 103, can have circular tracks (not shown) disposed in opposition to tracks, 203. In such an embodiment, small wheels, 201, need not be affixed to axels, 202, but rather a large plurality of such small wheels, 201, can be captured between the opposed tracks by raised walls at the edges of the tracks, to form two large roller bearings supporting the frame, 103, from the interior of the wheel, 101.

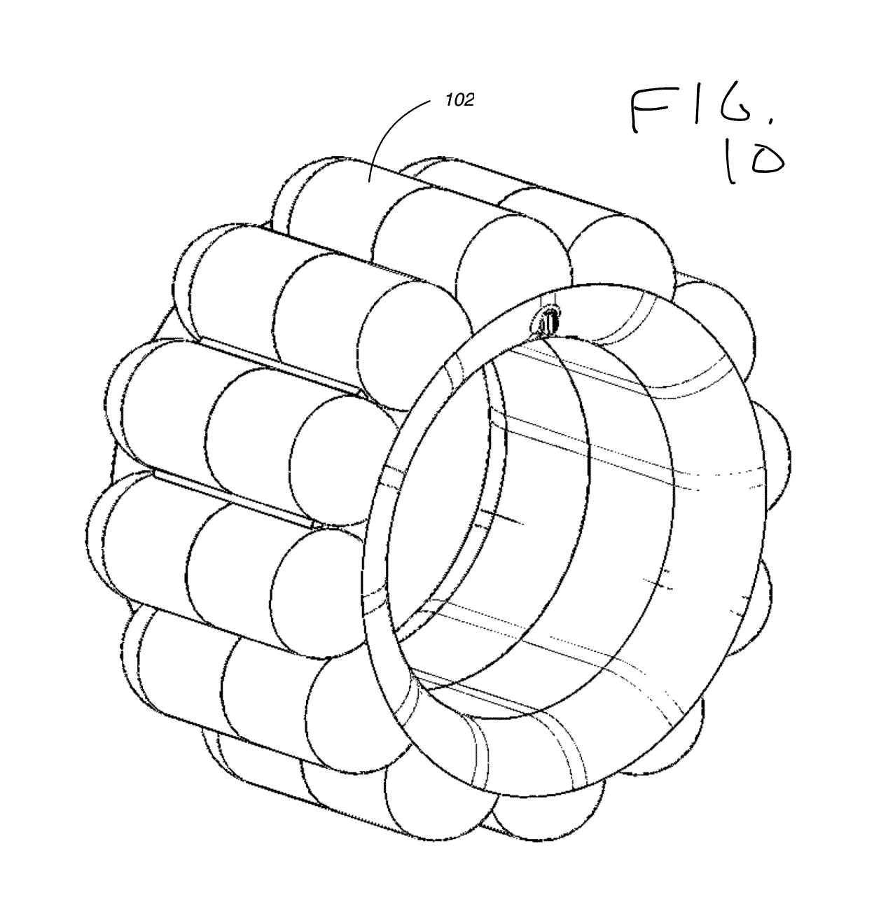

FIG. 10 shows the segmented tire of the exemplary embodiment, separate from its wheel. The tire could alternatively be constructed to have a single inflatable chamber, or plural joined chambers inflatable from a single point. Each of the plural chambers could alternatively be inflatable from a corresponding independent inflation point. For example, the chambers could be adjacently arranged, plural inner tubes, each with an inflation valve stem, the entire tire being then covered with a tough outer fabric either with or without a purpose-specific tread bonded to the contact surface thereof. The tire could alternatively have a flat tread region, rather than the segmented tread region shown, whether single or multiple chambers are used. The tire could also be formed of a conformable material, such as an elastomer, gel-filled envelope of similar shape to that shown, or foam, or the tire could be of a hard material, such as a plastic or hard rubber, or a combination of such materials. The selection of tire material can depend on the use to which the cart will be put. Specific materials may impart particular advantages or characteristics for which those materials are known. For example, a material having desired flexibility characteristics or traction characteristics for a particular terrain may be selected. Furthermore, the use of a wheel, 101, having a large width so as to provide a high inherent side-to-side stability, as explained further, below, will also produce a large contact patch with the ground which will both enable easier navigation of rough terrain and distribute the load presented by the cart over a larger area than done by conventional, one-wheeled carts. Distributing the load can help somewhat mitigate damage to delicate environments that might result from passage of the cart over such an environment, or in a military application can lessen the likelihood of triggering pressure-sensitive ordinance such as land mines, perimeter monitoring sensors or other similar equipment.

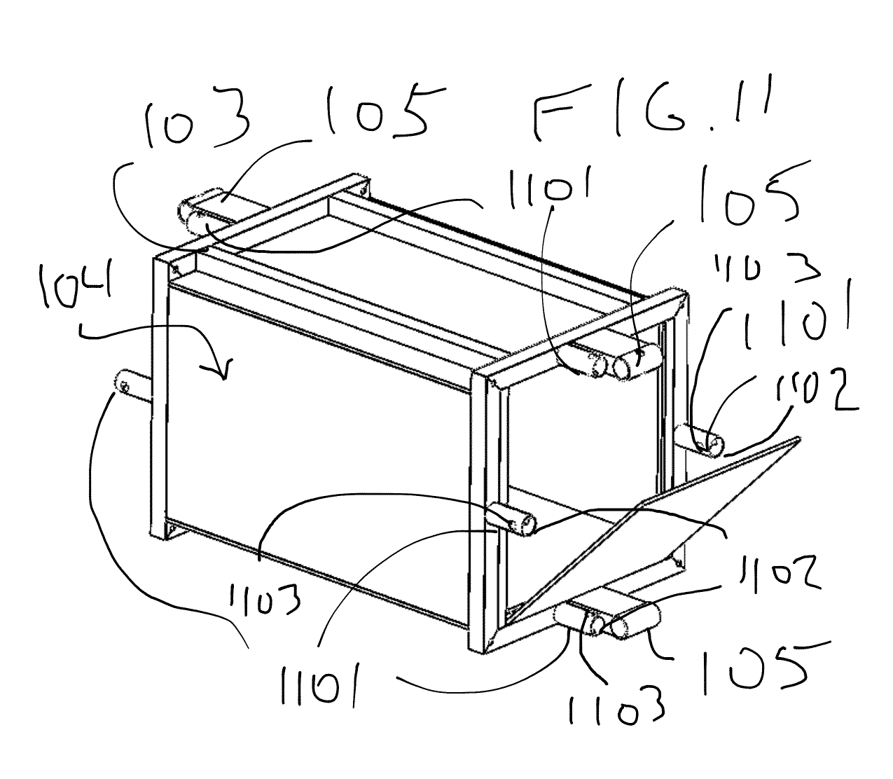

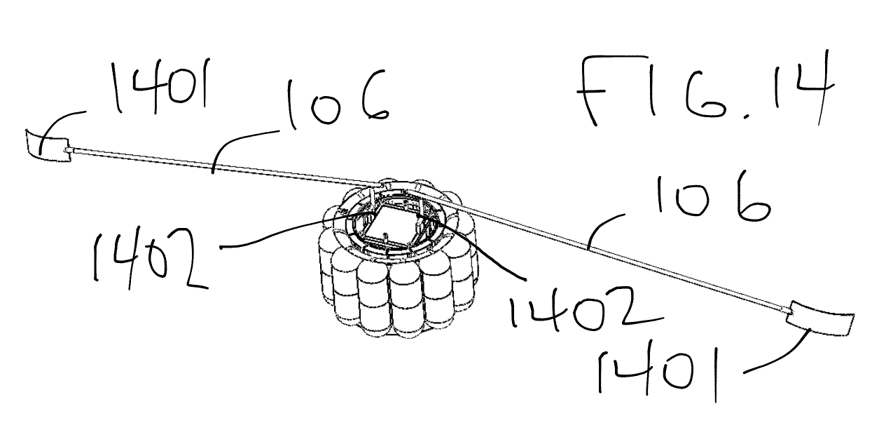

FIG. 11 shows the frame, 103, and container, 104, along with the mounting brackets, 105. Mounting brackets, 105, are arranged with sockets aligned parallel with a radial direction from the wheel. Mounting brackets, 105, are those illustrated in connection with the embodiments described above. Additional mounts, 1101, are aligned parallel with an axial direction from the wheel. Each mounting bracket, 105, and mount, 1101, has defined therein a socket, 1102, into which can be received a handle (not shown), and a hole, 1103, into which can be received a clevis pin (not shown). Alternative embodiments, such as handles with threaded ends can also be used to attach handles to mounting brackets, 105, or to mounts, 1101. See, also, FIG. 14, which shows attaching oarlocks to two mounts, 1101; attaching oar heads to two handles; and using the handles (now oars) in connection with the oarlocks to turn the cart into a small rescue or transport boat, or the like.

In the embodiment illustrated in FIG. 11, the frame, 103, and container, 104, are integrated into a single component, providing additional strength to the unit; however, in an alternative embodiment, the frame, 103, can include rails on which container, 104, can be slid in and out. Any suitable locking mechanism can retain the container, 104, in place within the frame, 103, in such an embodiment.

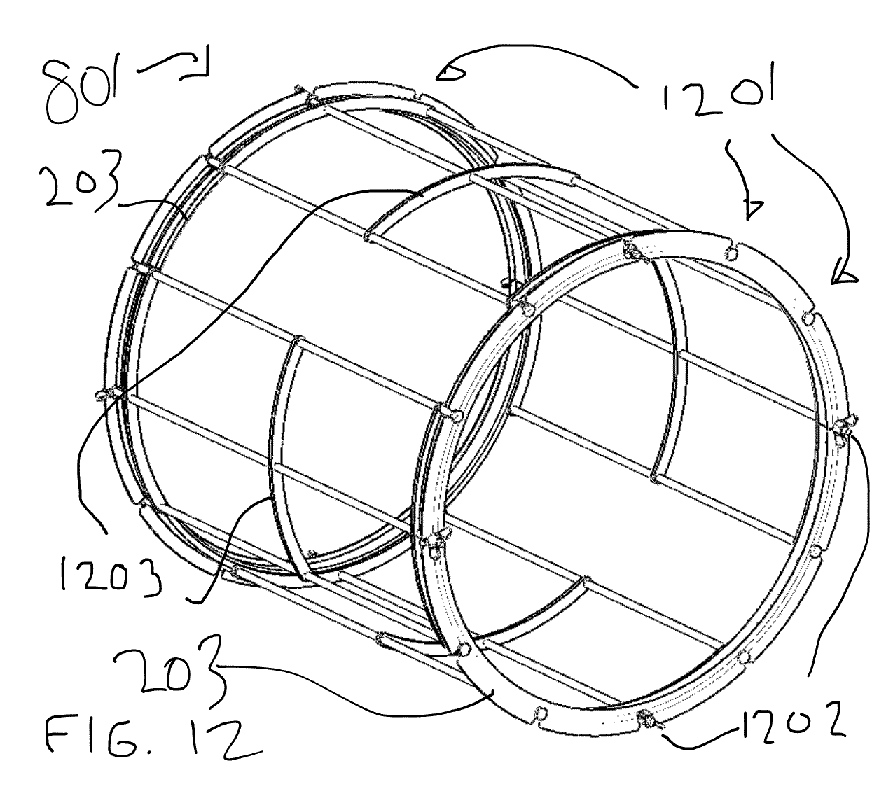

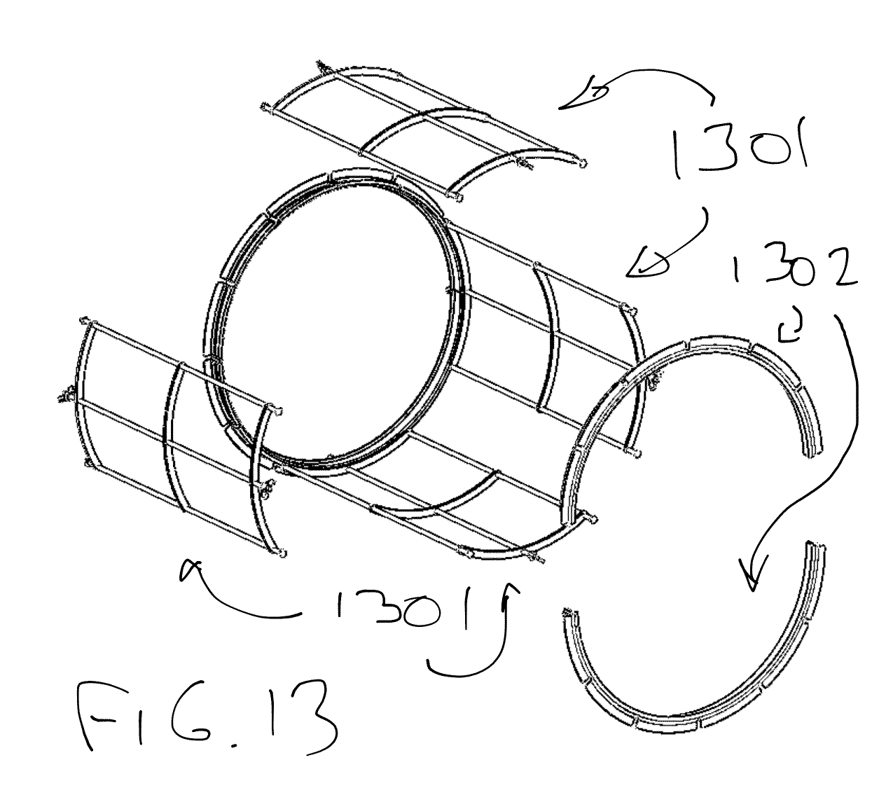

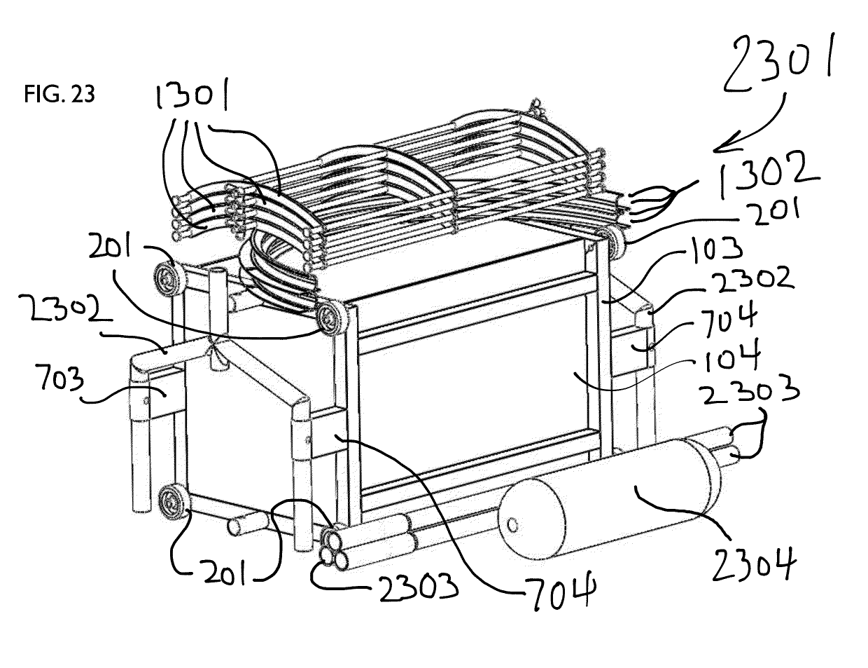

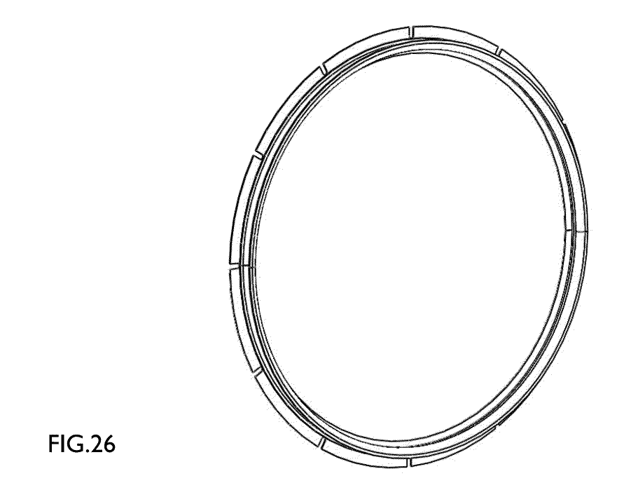

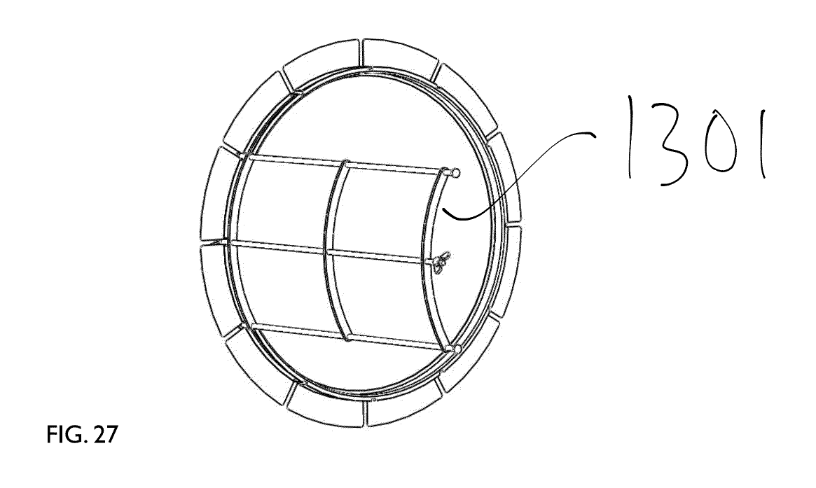

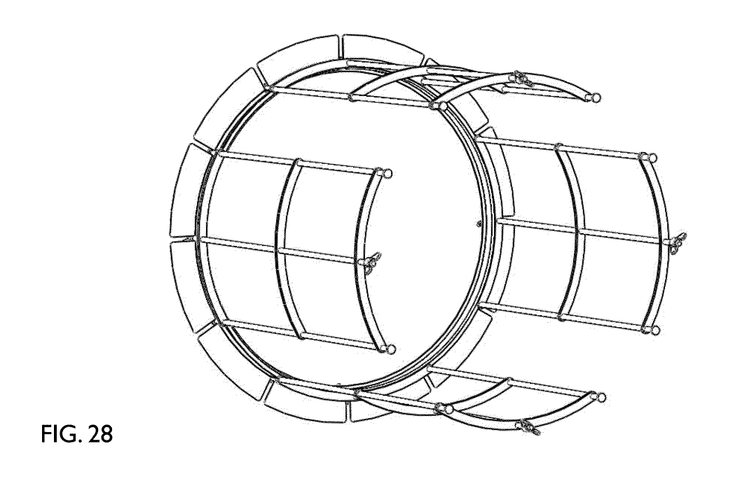

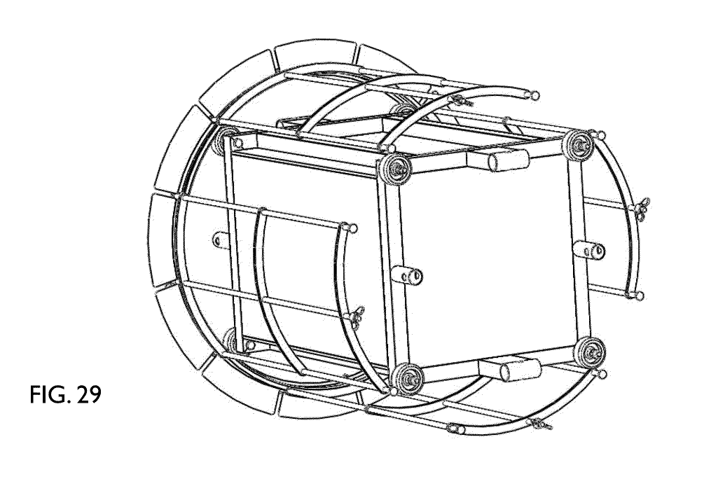

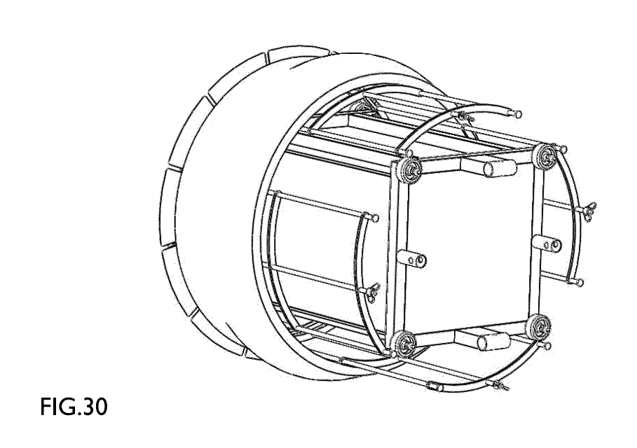

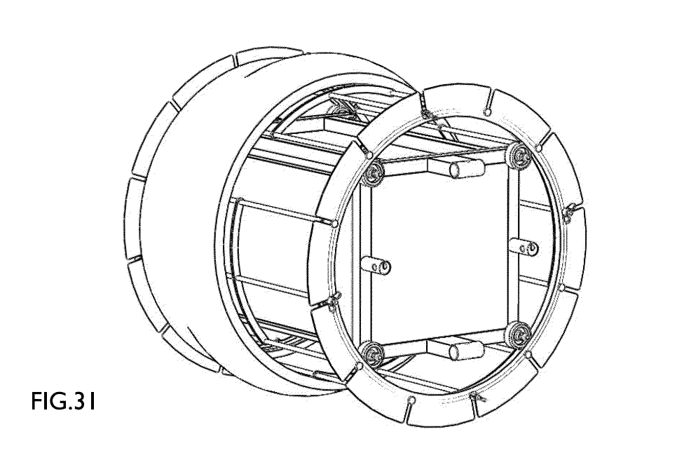

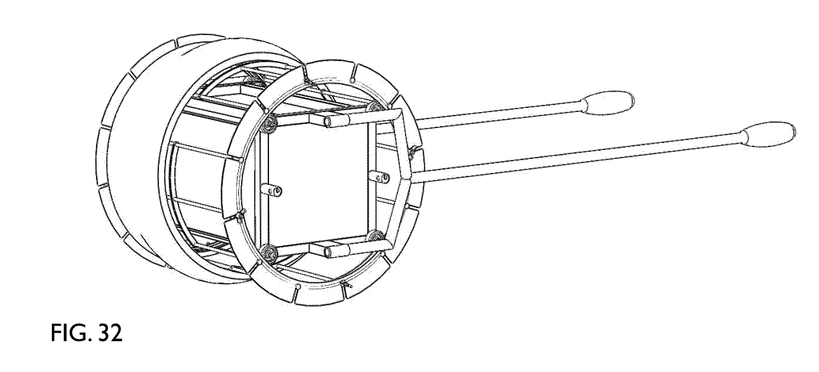

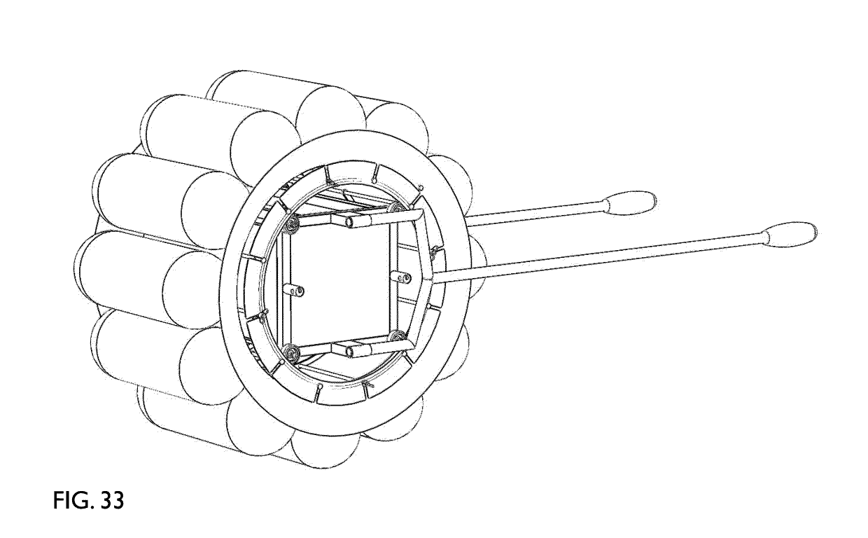

FIGS. 12 and 13 show the construction of the cage, 801. In FIG. 12, the assembled cage, 801, is shown, comprised of tracks, 203, having slots, 1201, into which are received transverse bars, 1202. Transverse bars, 1202, are first assembled into groups held together by circumferential bars, 1203, and are held in the slots, 1201, of the tracks, 203, by threaded ends and wing nuts, 1204. Assembling the cage, 801, of discrete groups of components, as shown in FIG. 13, permits the components to be partially assembled, inserted into the center of the wheel, and then assembly completed, yielding the form shown in FIG. 12. The assembly process is described in greater detail, below. (See, FIGS. 23-33, for example.) As shown in FIG. 13, groups of three transverse bars, 1202, and three circumferential bars, 1203, can be pre-assembled into cage wall sections, 1301. The bars may be welded, fastened by threaded parts, or held together by any other suitable means. Further, FIG. 13 shows that the tracks, 203, each comprise two track halves, 1302. The track halves are held in their completed configuration in the exemplary embodiment when the cage wall sections, 1301, spanning the gap between the track halves, 1302, are fastened to the track halves, 1302, by wing nuts, as previously described.

FIG. 14 shows an embodiment of the cart, for example of FIG. 1, in which the two handles, 106, have been detached from mounting brackets, 105, and have oar heads, 1401, attached to one end. The oar heads, 1401, can be pinned in place with clevis pins, similar to the way the handles were shown to connect to the mounting brackets, 105, or the oar heads, 1401, can include ball detents that mate with the clevis pin holes in the handles, 106. The oars (assembled of handles and oar heads) attach to oar locks, 1402, that fit into any suitably located pair of mounts, 1101.

In yet other alternatives, one or more handles, 106, can be mounted to mounts, 1101, with the wheel laid on a side with the opening of the container up. In that configuration, the handle(s), 106, can provide support for a tarpaulin, lines, or other items, such that a shelter, covered or uncovered operating room with supplies, covered or uncovered pantry, covered or uncovered remote equipment enclosure, or the like can be formed.

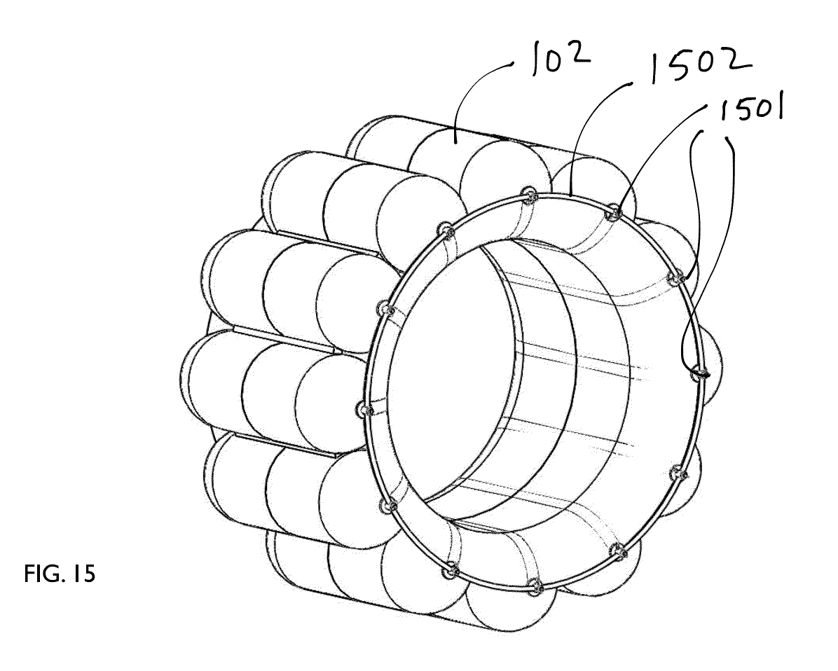

FIG. 15 shows the tire, again apart from its wheel, having plural inflatable tire segments, 102. The inflatable tire segments, 102, are arranged transversely across the tread region defined by the circumference of the tire, parallel to the axis of rotation of the wheel, i.e., axial to the wheel. Thus, as the wheel traverses a path along the ground, each inflatable tire segment, 102, sequentially contacts the ground along the path as the wheel rolls. In this embodiment, each inflatable tire segment, 102, has attached to one end thereof a valve, 1501. Each valve, 1501, is connected to adjacent valves, 1501, to each side thereof by a hose, 1502. The configuration and arrangement of the valves, 1501, together with the hoses, 1502, permits manual filling of any one or more inflatable tire segments, 102, with an inflation fluid, such as air, another gas, or the like, as well as isolation of any inflatable tire segment, 102, such as may be desired in the event of a puncture.

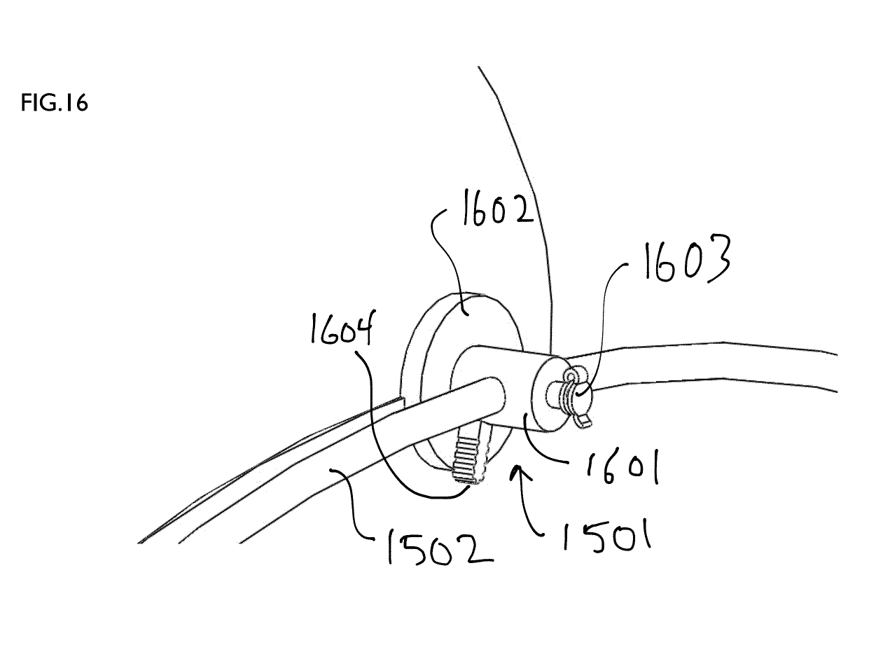

The detailed valve arrangement is next described in connection with FIG. 16. Each valve, 1501, has a valve body, 1601, having a flange, 1602, by which the valve is attached to the inflatable tire segment, 102. The valve may be welded, glued, adhered, clamped, or otherwise fixed to the inflatable tire segment, 102, using any suitable means known in the art. Each valve has a valve cap, 1603, that seals the valve closed when not in use for inflating or deflating one or more inflatable tire segments, 102. In addition, each valve has a lever, 1604, by which a gate or switching valve can manually effect communication of inflation fluid from the valve cap, 1603, to the inflatable tire segment, 102, or close off such communication. Hoses, 1502, attach to the valve body, 1601, at a point between the valve cap, 1603 and the gate or switching valve operated by lever, 1604, such that inflation fluid can be caused to communicate with the hoses, 1502, depending on the position of the lever, 1604. A switching valve with three positions, for example, could effect communication from the valve cap, 1603, to the hoses, 1502, only, in a first position; to the hoses, 1502, and the inflatable tire segment, 102, in a second position; and, to the inflatable tire segment, 102, only, in a third position.

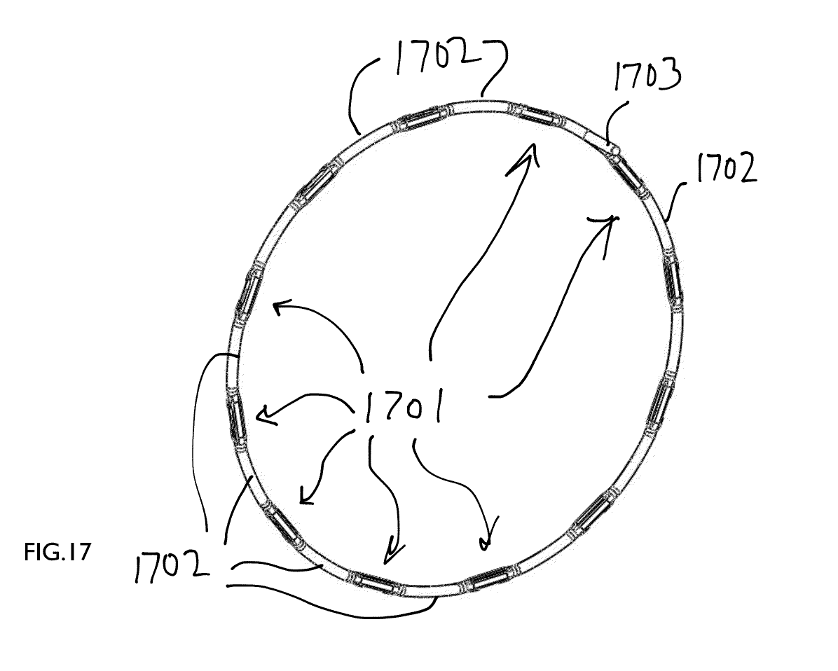

FIG. 17 illustrates an alternative valve arrangement which permits the automatic inflation and deflation of the wheel, 101, using an arrangement of reed valves and hoses forming a manifold. A plurality of reed valves, 1701, equal in number to the number of inflatable tire segments, 102, forming the wheel, 101, are interconnected by hoses, 1702. The reed valves have hollow bodies, such that this interconnected arrangement forms an inflation fluid manifold through which inflation fluid is distributed or exhausted. A port, 1703, is provided in one segment, instead of a hose, such that inflation fluid, for example air, or another suitable gas, can be introduced or exhausted from the manifold as desired by a bi-directional pump (not shown).

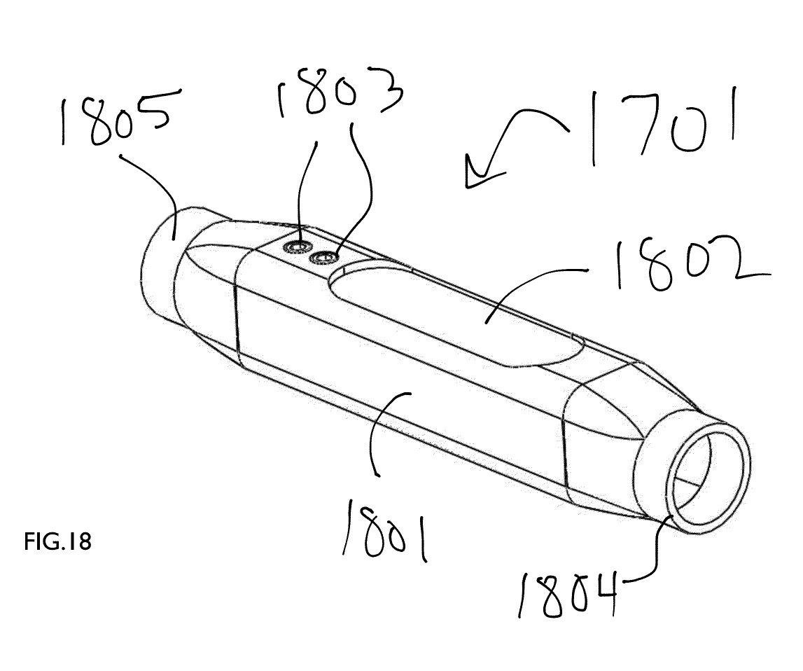

An exemplary reed valve, 1701, is now described in connection with FIG. 18. The valve, 1701, has a hollow valve body, 1801. A port is defined through one side of the valve body, 1801, which is covered by a reed, 1802, which slightly interferes with the opening defining the port. The reed, 1802, can, however, move through the port in either direction by application of sufficient pressure. The reed, 1802, is secured in place in the port by any suitable means, such as fasteners, 1803, welding, gluing, adhering, or the like. In order to connect into the manifold system as previously described, the valve body, 1801, includes connection ports, 1804 and 1805.

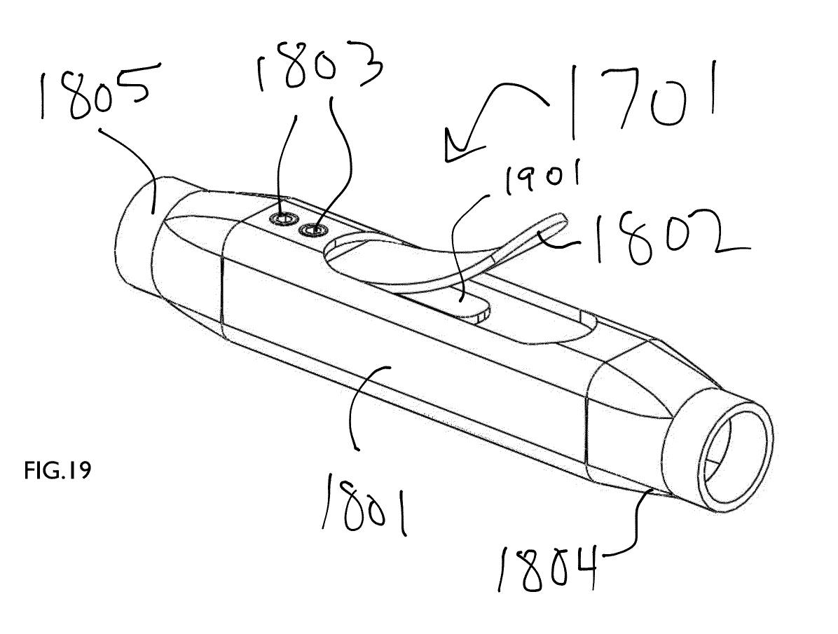

FIG. 19 shows the valve under the condition that the pressure of the inflation fluid in the manifold (and so, in the valve body, 1801) is higher than the pressure in the inflatable tire segment, 102, to which the valve is attached. Thus, the reed bends open in the outward direction. Within the valve body, 1801, can be now seen a spring, 1901, that causes a higher pressure in the inflatable tire segment, 102, to be required to exhaust inflation fluid from the segment than the pressure required to fill the segment with inflation fluid from the manifold. By arranging the valve thus, it will be required to reverse operation of the bi-directional pump to exhaust inflation fluid from the inflatable wheel segments, and inflation fluid will not be pushed out by the expected periodic loading of the inflatable tire segments during ordinary rolling operation of the wheel.

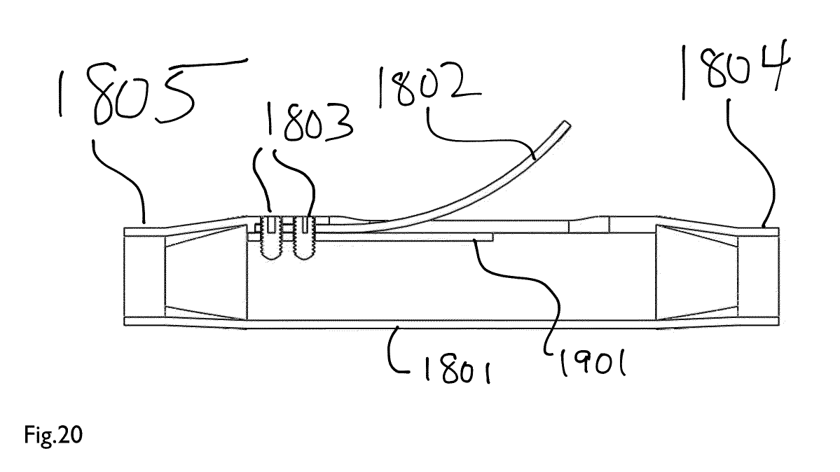

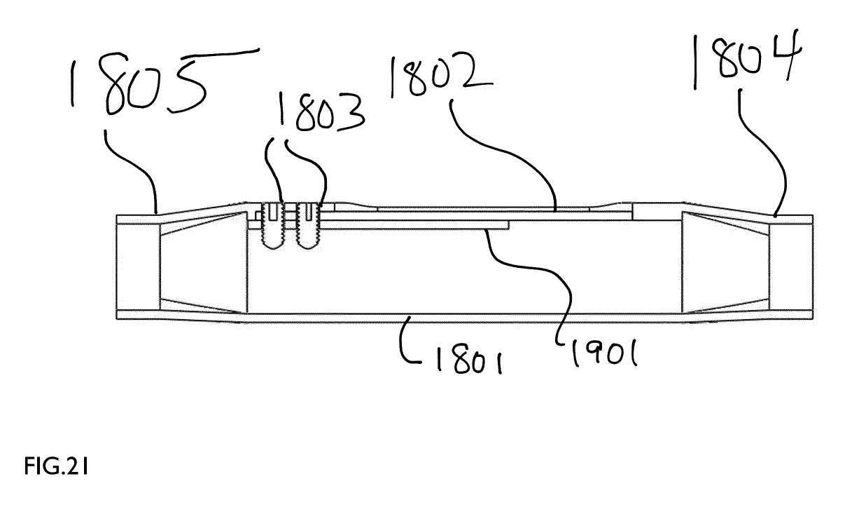

FIGS. 20 and 21 show the reed, 1802, in open and closed positions, respectively, as inflation fluid is introduced into the inflatable tire segment or retained by the inflatable tire segment. When it is desired to exhaust inflation fluid from the segment, the bidirectional pump operation is reversed and each segment is loaded with the mass of the cart and its load, by rotation into contact with the ground, such that the manifold pressure is then below that of the inflatable tire segment when loaded, by a sufficient amount to permit the reed, 1802, to bend back against spring, 1902, and inflation fluid to thus be exhausted.

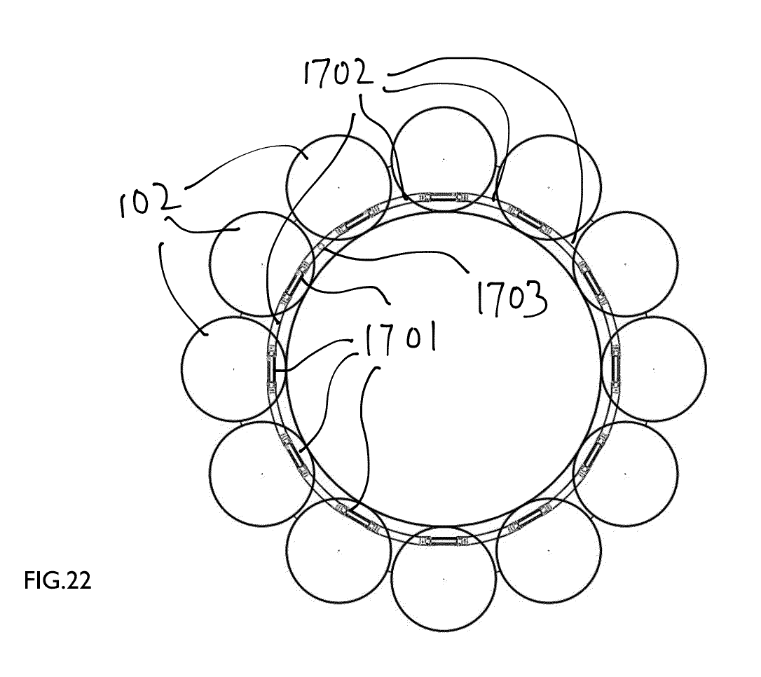

FIG. 22 shows the arrangement of the manifold against the tire. Each reed valve, 1701, is bonded, welded, affixed, clamped, or otherwise attached and sealed to a corresponding inflatable tire segment, 102.

The cart of the present invention is advantageously configured and arranged to be provided in both assembled and kit form, as now described in connection with FIGS. 23-35. Aspects and variations on aspects of the illustrative embodiments presented may particularly lend themselves to the kit embodiment now described, and other embodiments having features that lend themselves to this and other kit embodiments will also be apparent as the description of kit embodiments is read.

As shown in FIG. 23, the cart of the embodiment of FIG. 1, for example, can be disassembled into a kit, 2301, of compactly stored components. In the stowed, or kit, configuration, 2301, each of the elements previously described can be seen as separate components of the kit, 2301.

Beginning with the top of the stack of components, elements of the cage, 801, are seen. Four pre-assembled cage walls, 1301, are stacked on top of four track halves, 1302.

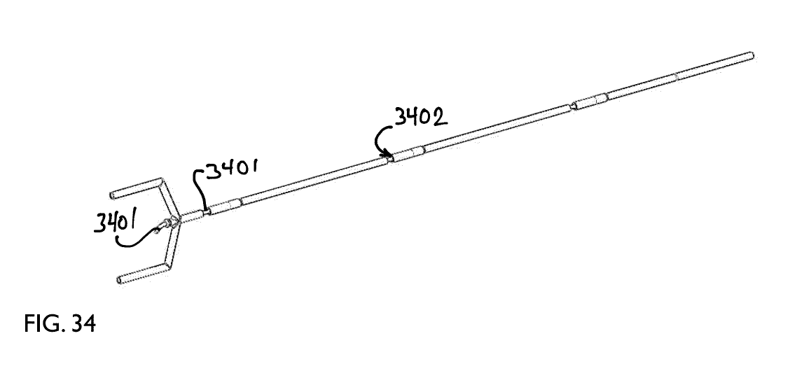

The cage walls, 1301, and track halves, 1302, rest atop frame, 103, which, in this kit includes an integral container, 104. Two handles (FIG. 1, 106) having bifurcated ends (FIG. 7, 701) have each been disassembled into a handle fork, 2302, and a bundle (one of two shown) of three handle rods, 2303. Each handle fork, 2302, and each of the handle rods, 2303, can have a threaded end, and thus screw together, or they can have slip joints at the ends which are then pinned together with cotter pins through suitably located holes (not shown). Each bundle of three rods together with a corresponding handle fork can alternatively include a shock cord, 3401, running through an interior bore, 3402, of each rod, 2303, and the handle fork, 2302, as shown in FIG. 34, rendering the entire bundle self-assembling by simply aligning the rods and the handle fork and allowing the shock cord to pull the assembly together. In the illustrative embodiment, the handle forks, 2302, are partially pre-assembled to the cart, by simply being unpinned in their sockets, 703 and 704, and slid to a more convenient storage position, while the handle rods, 2303, are simply and conveniently stacked together.

Placed, in the view of FIG. 23, at the front of the stacked kit, is a sack containing the now-deflated inflatable tread element or elements, 2304, which are rolled and stored in the bag similarly to the storage of a sleeping bag in its stuff bag.

Variations on the disassembly of the cart into kit form are possible. For example, the cage, 801, can be broken down into more or fewer elements. The loose elements of the kit, such as cage walls, 1301, track halves, 1302, handle rods, 2303, can be defined, or by design changes that would be evident to skilled artisans can be further disassembled, to be small enough to fit within the container 104. Other embodiments, described below, include folding handles that could fit into the container, as well as a foam tire in a covering that could be rolled up to also fit in the container, together with the other structural components as discussed herein. The illustrative embodiments have the advantage that the number of components and sizes of the components leads to easy handling and quick assembly and disassembly with low risk of misplaced or lost components.

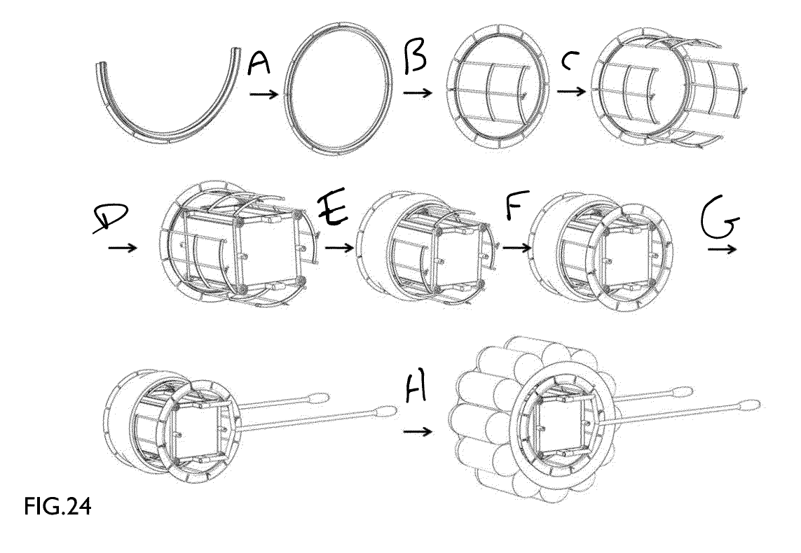

The kit of FIG. 23 is assembled into a complete cart, as shown in FIG. 24. A first set of track halves (FIG. 23, 1302) are arranged, step A, to form a track configuration. The track configuration receives, step B, a first cage wall (FIG. 23, 1301) which holds the track together for subsequent steps by bridging the two track halves. Three more cage walls are added, step C. The frame (FIG. 23, 103), which in this embodiment includes the integral container (FIG. 23, 104), is slid into the partially assembled cage so that wheels (FIG. 23, 201) in the corners of the frame engage the track that is now fully assembled, step D. The inflatable tread element or elements (FIG. 1, 102) of the tire for the wheel is slid onto the cage from the unassembled end, step E, after which the remaining two track halves (FIG. 23, 1302) can be received onto the cage walls (FIG. 23, 1301), step F. The transverse rods having threaded ends fitting into slots in the tracks hold the cage elements and the tracks together, as previously described. The handles are screwed together, pinned, or otherwise secured, as previously described, and fixed to the frame, for example by sliding to a working position in sockets, 703 and 704, and pinning, also as previously described, step G. Finally, the tire is inflated, step H, producing the complete, working cart.

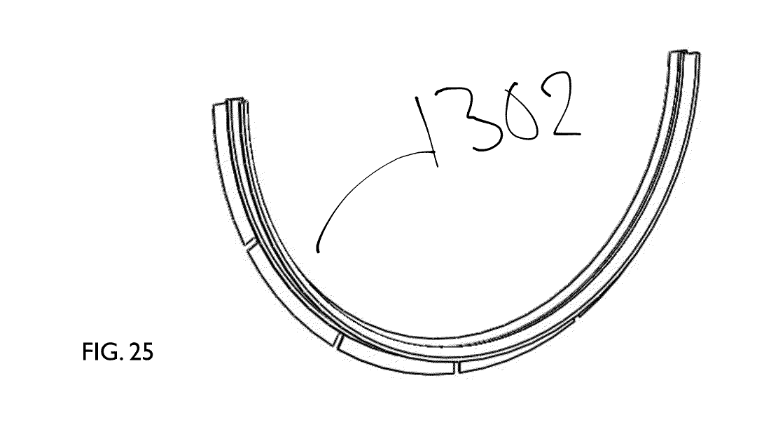

The state of the cart before step A, and after each of steps A through H, is illustrated in FIGS. 25-33, respectively.

The exemplary alternatives shown in the FIGs. can be recombined in various other permutations within the scope of this disclosure and the invention that will be evident to the skilled artisan only once given the suggestions shown.

For example, it should now be evident that various attachments, handle configurations, and transportable items render the cart useful for a variety of military, emergency services, search and rescue, and similar uses in the field. Uses by medics to bring medicines and equipment directly to a patient and also for patient transport should be evident. Other potential users include but are not limited to all potential disaster relief and rescue groups such as police/fire, EMS, tactical/technical rescues, and ski patrol. The specialized equipment employed by each of those groups can be adapted to the inventive concept. For example, fire jumpers can cart in various types of equipment for firefighting, and the tent configuration can, for example, be equipped with a fire-shelter fabric. Examples of consumer uses of the cart include but are not limited to carts for beachgoers, tailgaters, campers, gardeners, restaurateurs, bar owners, and household uses. In such products, the handles can support a tabletop, or flexible sheet or fabric, usable to carry additional items and small children. The cart itself can store bottles of any kind in a horizontal rack inside the cargo area, or can house a complete tent and survival kit including food, shelter, cooking, and medical supplies, which can be brought into and out of rough or uneven terrain.

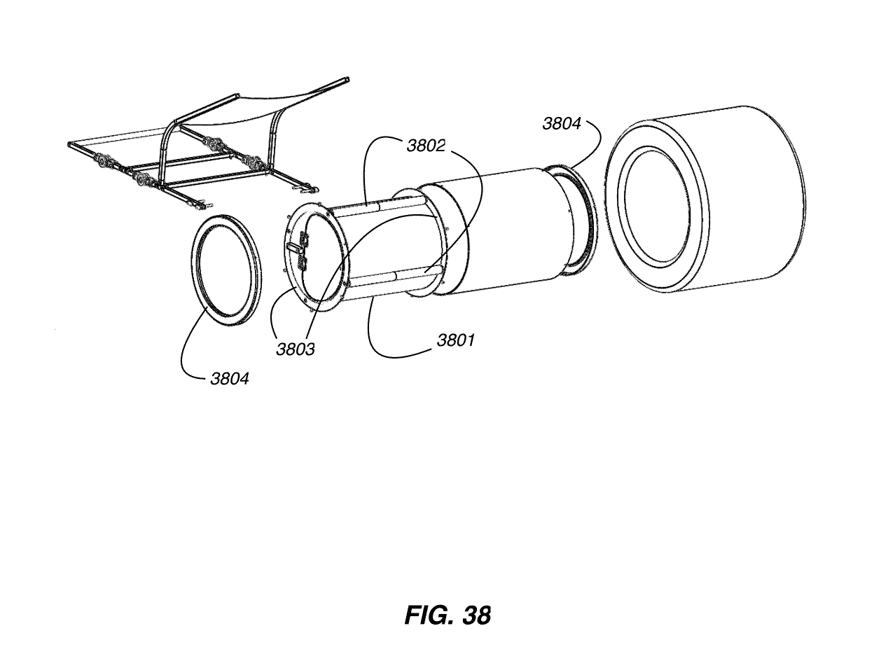

As shown in FIG. 36, an alternate embodiment of the wheeled cart includes a central cargo container, 3601, with a circumference, 3602, surrounded by a wheel, 3603, with a tire, 3604. The suspension of the cargo container, 3601, within the wheel may be as explained above in connection with other embodiments, or may be as will be explained further in connection with FIG. 38, below. The tire and wheel have a width, 3605, sufficient to maintain the center of gravity of the apparatus as a whole within a ground contact area approximately spanning the width, 3605, over a range of expected terrain and loading variations. The width, 3605, which may be narrower than the width of the apparatus as a whole, should nevertheless be selected to provide a non-zero degree of stability over a range of tilt from side to side. For example, the width, 3605, may be made to accommodate a tilt relative to horizontal of the axis of rotation of the wheel, 3603, of up to 15°, 30°, 45°, 60°, or more, depending on any restrictions on either the width or diameter of the structure as a whole. That is, for a given cargo capacity, weight, and tire construction, the width, 3605, is selected to maintain stable operation without requiring manual stabilization by an operator up through a specified degree of tilt. By selecting dimensions to accommodate the expected terrain as described, the wheeled cart needs only one wheel to be stable while in motion.

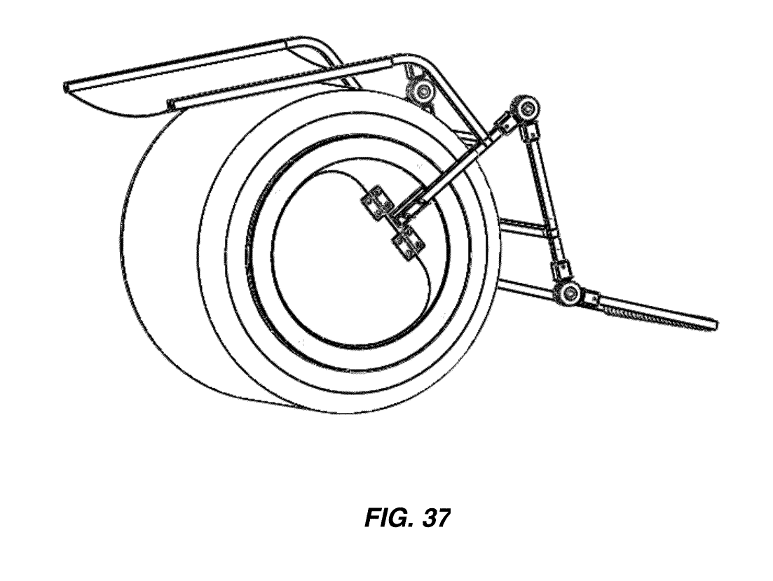

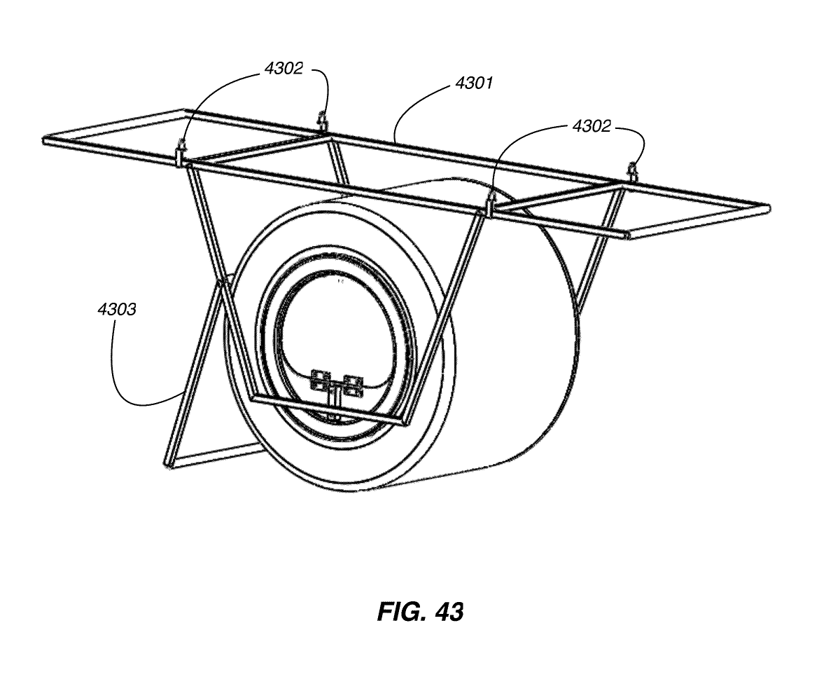

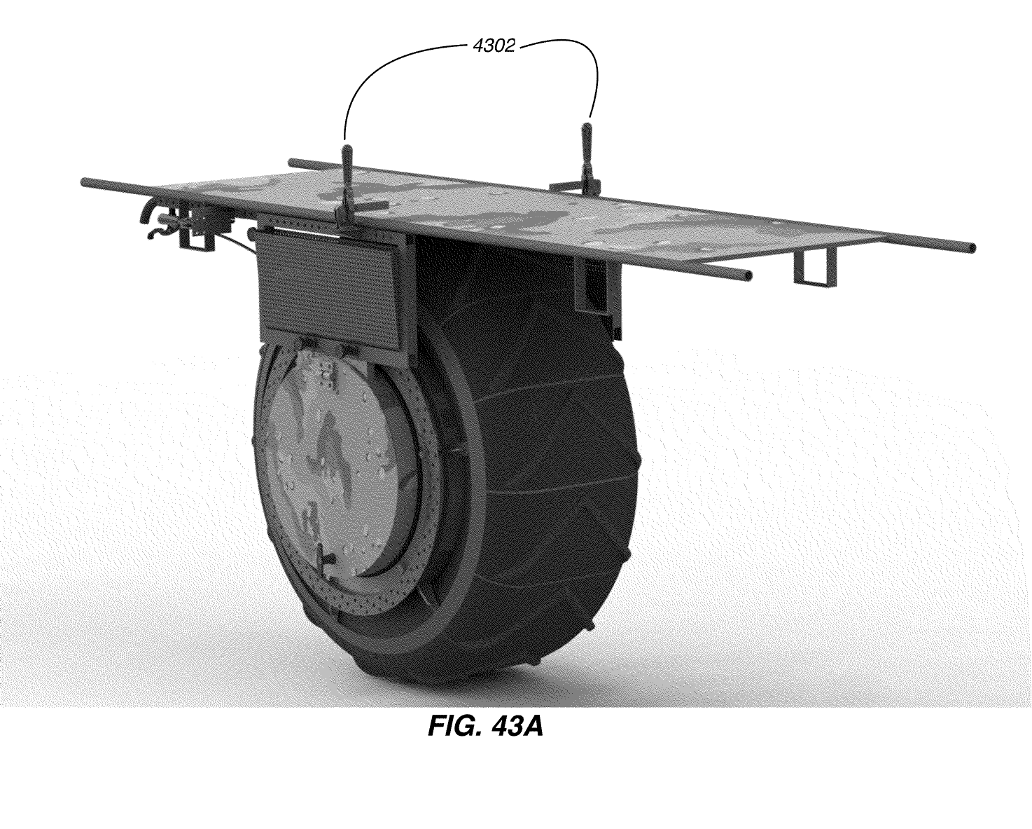

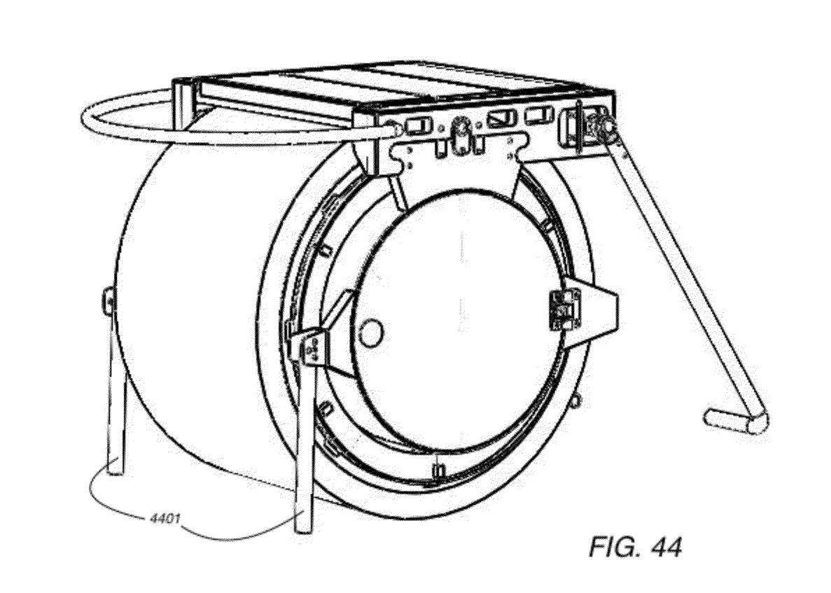

In order to provide stability when not in motion, or not held by an operator who can control the forward and back motion of the cart, an articulated handle, 3606, is provided with locking joints, 3607, that lock the handle, 3606, in a position for moving the cart, or as shown in FIG. 37, lock the handle, 3606, in a position for maintaining the cart in a stable position while not under control of an operator. An alternate handle embodiment is shown in FIG. 36A. In this embodiment, handle, 3606, is also provided with locking joints, 3607. In the embodiment of FIG. 36, locking joint, 3607, is of a type that holds its position by a detent mechanism built into the pivot, while in the embodiment of FIG. 36A, locking joint, 3607, is of a type that holds its position by use of a thumbscrew clamp adjacent to the pivot. Also evident in the embodiment of FIG. 36A is the option of using a perforated rail for the handle, 3606, and other suitable structures, whereby suitable hold-down clamps, e.g., lever lock clamps, 4302 (See, also, FIG. 43), for a stretcher, hard or soft platform, additional swing-down legs (FIGS. 5a and 44, 4401), or other apparatus, can be securely fastened to various positions along the rail. Examples of swing-down legs, 4401, are shown in FIGS. 5a and 44.

In order to increase the control exercised by the operator over the cart, one or more hand brakes can be attached, as shown in FIG. 36A. Any suitable hand brake design can be employed, such as a rim brake, a disk brake, a spoon brake, or a drum brake, depending on the braking surface and mechanism the designer desires to make available. Each such braking system includes a brake handle, 3613, and cable, 3614, to provide braking control to the operator. Instead of a cable, 3614, a hydraulic or other suitable control mechanism can be used.

In addition, as shown in FIGS. 36, 36A, and 37, the handle, 3606, may include mounting points, such as hold-down clamps, 4302, for additional carrying apparatus, such as a canvas or hard-surfaced platform, 3608. Access to the interior of the central cargo container, 3601, may be had through a door on either or both sides, 3609 or 3610. Alternatively, a cart, 3603, having two circumferential tread regions separated in the middle by an open space could allow access to a door (optional), located on a transverse surface of the central cargo container, 3601. Such a door would be accessible through the framework of the cargo container, 3603, in the open space between the circumferential tread regions.

The exploded view of FIG. 38 illustrates a suspension system useful in connection with the cart of this embodiment. In this embodiment, the central cargo container, 3601, includes a cylindrical body, 3801, to which rollers, 3802, are mounted by axles (not shown), suspended from the cylindrical body, 3801, via flanges, 3803. Optionally, other mounting methods of the rollers, 3802, may be used, such as fixed brackets; or, a larger or smaller number of rollers, 3802, may be used. If only two rollers are used, they should be placed approximately 90° apart, approximately 45° to each side of a vertical plane through the axis of the cart when under way. Any of these embodiments may include retaining rings, 3804, attached either to the cylindrical body, 3801, or to the wheel, 3603, so as to provide a thrust bearing preventing the central cargo container, 3601, and/or the rollers, 3802, from sliding axially out of the wheel, 3603, when the cart is moved. The inner cylinder can include ball casters facing the retaining rings, 3804, to make a smooth-running thrust bearing. Sweeps or other sealing apparatus can be affixed in fixed positions before and/or after each roller, to keep the bearing surfaces relatively clean when operating in a dusty, muddy, wet, or other environment likely to introduce material that would affect bearing performance. The wheel, 3603, including the tire, 3604, is mounted circumferentially about the container, 3601. The tire, 3604, may be a multi-chambered or single-chambered design as described above. Materials of which the tire may be constructed may include any, or any combination of, suitable natural or artificial material such as polymer, monomer, elastomer, gel, natural or artificial rubber, woven or non-woven fabric, etc., formed into rigid, semi-rigid, closed-cell foam, or open-celled foam, skinned foam, etc. depending on what demands may be put on the cart in use. Specific materials may impart particular advantages or characteristics for which those materials are known. The tire may include different types of covers with different materials, or a cover of any type of desired material may be attached to the wheel or tire, covering the tire by connecting such cover to attachment points on the wheel or tire. Furthermore, the use of a tire, 3604, having a large width, 3605, so as to provide a high inherent side-to-side stability will also produce a large contact patch between the tire, 3604, and the ground which will both enable easier navigation of rough terrain and distribute the load presented by the cart over a larger area than done by conventional, one-wheeled carts. Distributing the load can help somewhat mitigate damage to delicate environments that might result from passage of the cart over such an environment, or in a military application can lessen the likelihood of triggering pressure-sensitive ordinance such as land mines, perimeter monitoring sensors or other similar equipment.

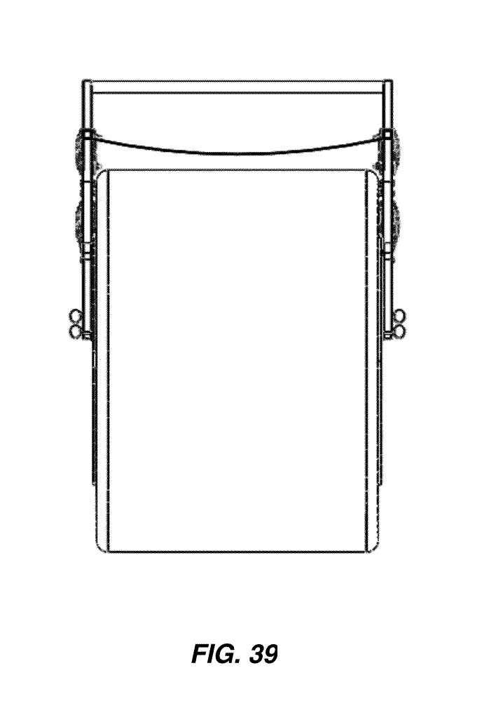

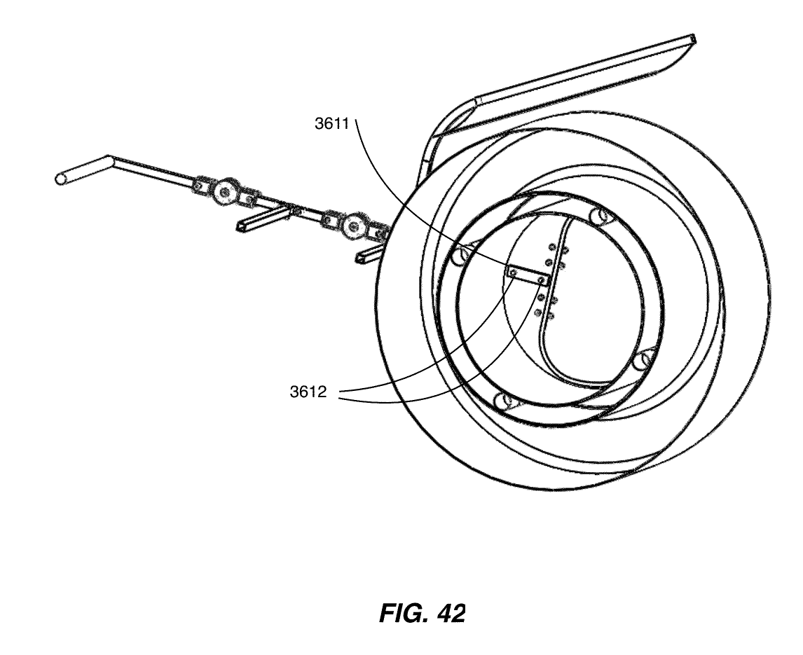

FIGS. 39, 40, 41, and 42 show the components described above from a variety of angles, and in section view (FIG. 42), to clarify the geometric relationships there between.

An alternate version of this embodiment, as shown in FIG. 43, substitutes a stretcher attachment frame, 4301, having stretcher clamps, 4302, and a fold-up stand, 4303, for the articulated handle (FIG. 36, 3606) previously described. This alternative embodiment can accommodate a variety of stretchers and back boards that can be clamped in place to the top of the frame, 4301, by clamps, 4302. Hold-down clamps, 4302, can be implemented as thumbscrews, lever lock clamps, or any other suitable clamps fixedly or moveably attached to the handles or structure of the cart.

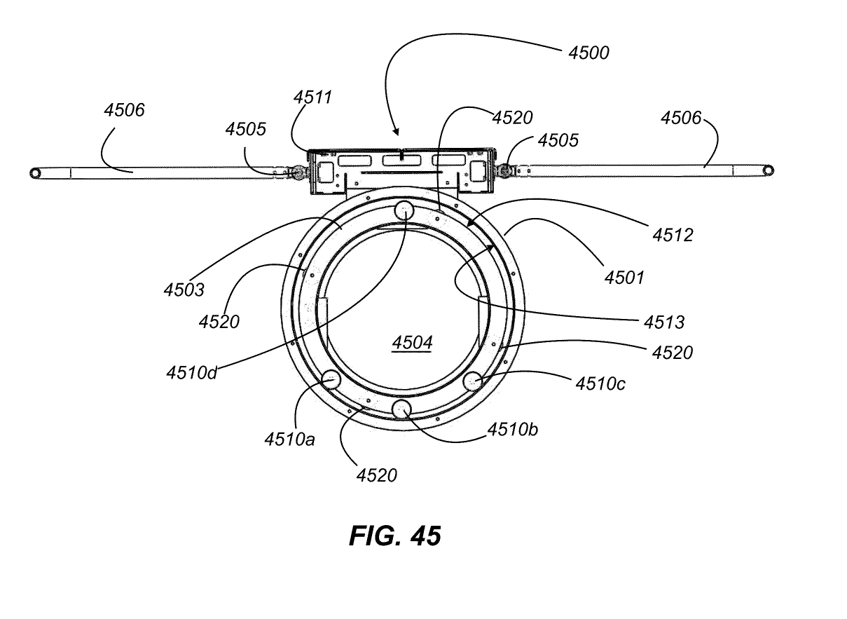

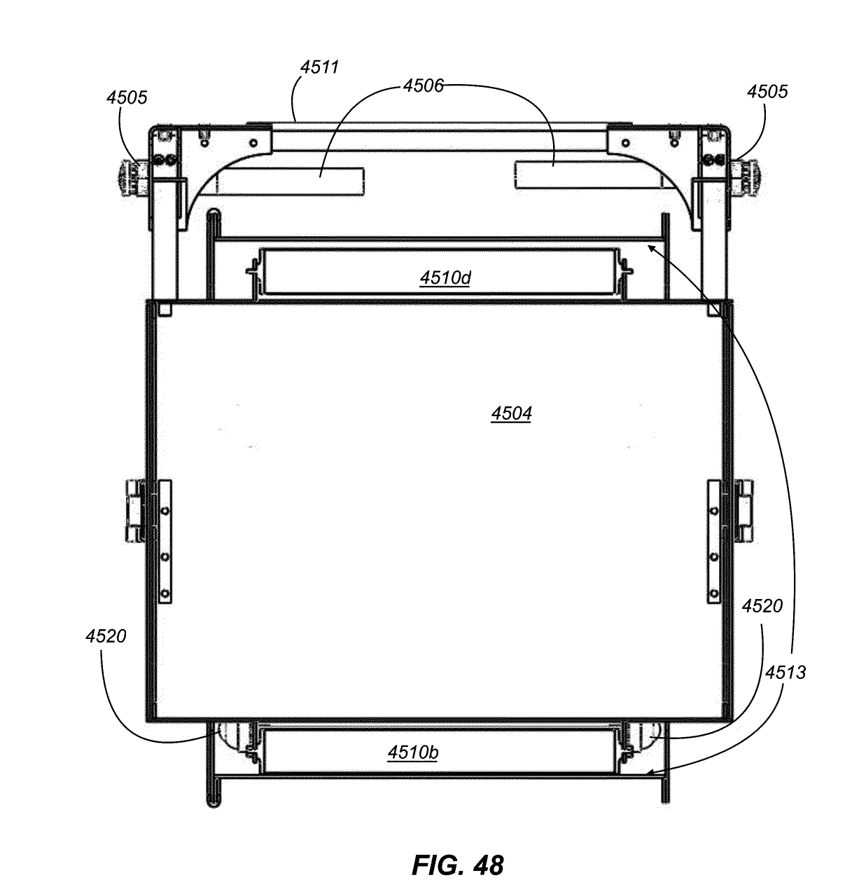

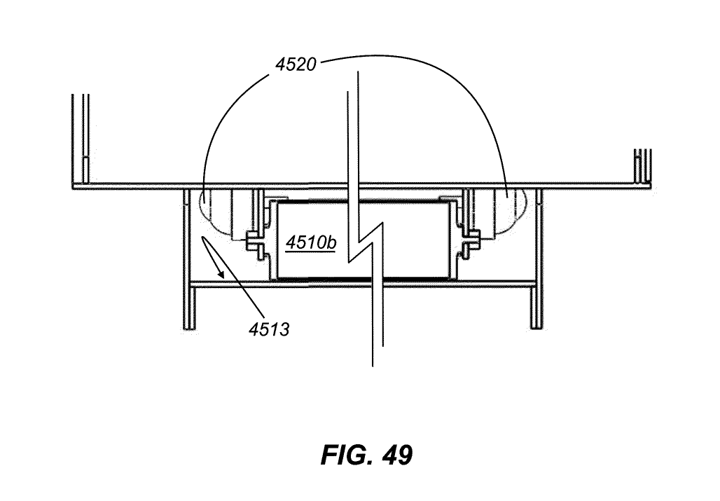

In the embodiment illustrated in FIG. 45, frame, 4503, is supported from the wheel, 4501, by four rollers, 4510. Rollers, 4510, span a width just less than the width of wheel, 4501, as seen in FIG. 48, for example. As described elsewhere herein, rollers, 4510a, 4510b, and 4510c, are distributed to support the cart, 4500, roughly at a point directly below the geometric center of the wheel, 4501, (roller, 4510b) and at two additional points approximately 45° to each side of the bottom roller, 4510b. The fourth roller, 4510d, is located at a point directly above the geometric center of the wheel, 4501, to provide support when the cart is tipped forward or back, rolled up or down hills, or moved roughly over bumpy terrain. The track, 4513, on the inner surface of the wheel, 4501, has a diameter just larger than the diameter described by the positioning of the four rollers, 4510, so as the provide clearance between the rollers, 4510, and the track, 4513, under certain circumstances, rather than a conventional close tolerance between the diameter of the track, 4513, and the diameter described by the positioning of the four rollers, 4510. By positioning the rollers, 4510, at an unconventional, loose tolerance position relative to the track, 4513, the cart system is more tolerant of dirt and debris infiltration, which can pass harmlessly through the system, using fewer components and requiring less maintenance than other embodiments described herein which use tight positional tolerances in combination with bearing seals and sweepers to keep dirt and debris out. On the other hand, simpler, inexpensive sweepers can be combined with the above-described loose tolerance positioning to provide a small amount of dirt and debris rejection together with rejecting larger dirt particles and items of debris. Also seen in FIG. 45 are four ball casters, 4520, positioned as thrust bearings behind flanges, 4512. The structure and operation of the ball casters, 4520, is further described below in connection with FIGS. 48 and 49.

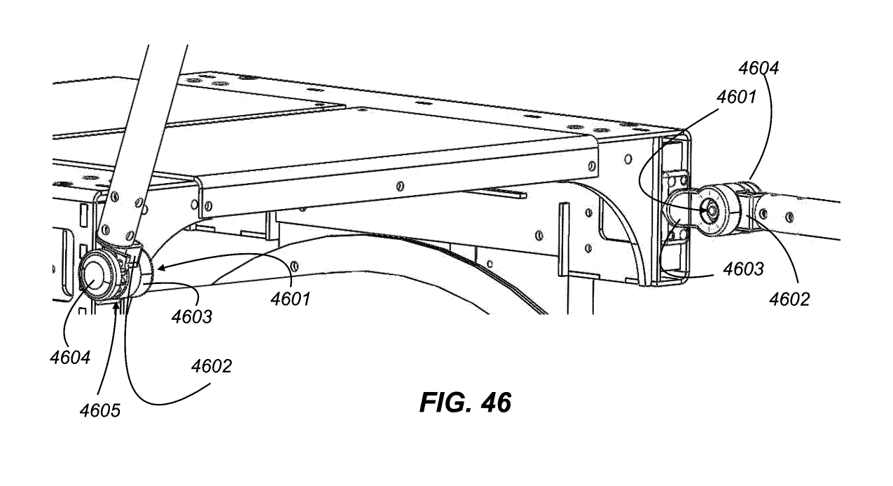

Further, in the embodiment illustrated in FIG. 45, the frame, 4503, of cart, 4500, includes a rigid, optionally detachable, tabletop structure, 4511. The rigid tabletop structure contributes to the structural integrity and strength of the frame, 4503, as well as providing a more stable work platform for specialized tasks or for carrying heavy equipment or other objects outside of the container, 4504. To the tabletop are attached handles, 4506, using locking hinges, 4505. In the case of the rigid tabletop structure, 4511, being detachable, the entire tabletop structure, 4511, and handle, 4506, assembly can be folded into a compact configuration, removed and stowed in the container, 4504, if desired. In the case of a non-detachable tabletop structure, 4511, the handles, 4506, can be folded into a compact storage position adjacent to the tabletop structure, 4511, or into a downward facing brace position, such that the cart can be stood in position at rest, or into any other desired rotational position accommodated by the locking hinges, 4505. The operation of the hinges, 4505, and the handles, 4506, is further explained in connection with FIG. 46.

Details of the hinges, 4505, can be seen in FIG. 46. Each hinge includes a pivot, 4601, and two arms, 4602 and 4603. In addition, each hinge includes a locking knob, 4604, attached to the pivot, and having splines or pins, 4605, that align with splines or holes in the two arms, 4602 and 4603, to lock them in a desired angular arrangement. Pivot, 4601, slides in and out along with the locking knob, 4604, to permit the splines or pins, 4605, to engage and disengage with the splines or holes. A spring or detent (not seen) internal to the hinge may preferentially hold the pivot, 4601, and locking knob, 4604, in the locked position. One arm 4602, of each hinge, 4505, is fixed to the tabletop structure, 4511, and the other arm, 4603, of each hinge, 4505, is fixed to a handle, 4506.

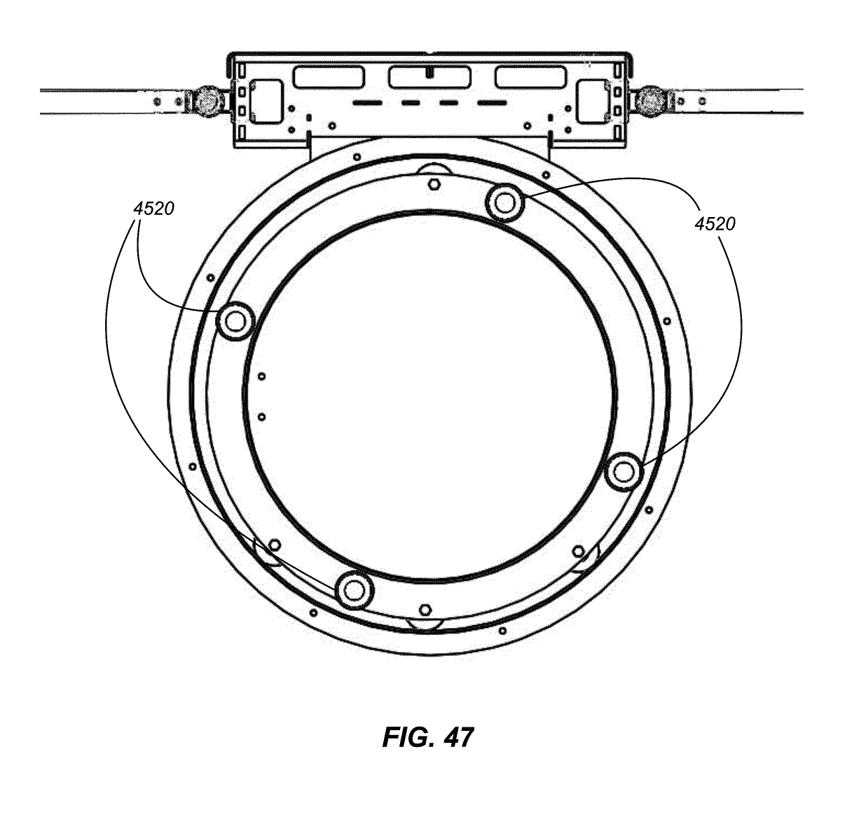

Ball casters, 4520, are more clearly seen in FIG. 47, in which the cutaway portion includes the flange against which the ball casters engage.

The cross-section view of FIG. 48 shows with additional clarity several of the foregoing features. The rigid tabletop structure, 4511, with handles, 4506, attached by hinges, 4505, is at the top of the cart in this view. The container, 4504, is somewhat wider than the wheel, 4501, and supported from the wheel, 4501, by rollers, 4510. The lack of concentricity between the wheel, 4501, and the container, 4504, is clearly seen in that roller, 4510b, is in contact with the track, 4513, inside the wheel, 4504, while the roller, 4510d, is not in contact with the track, 4513.

The view of FIG. 49 is a detail of the lower portion of the cart shown in FIG. 48. This view illustrates the loose tolerances permitting the easy expulsion of dirt and debris without jamming the system between the ball casters, 4520, and the flanges.

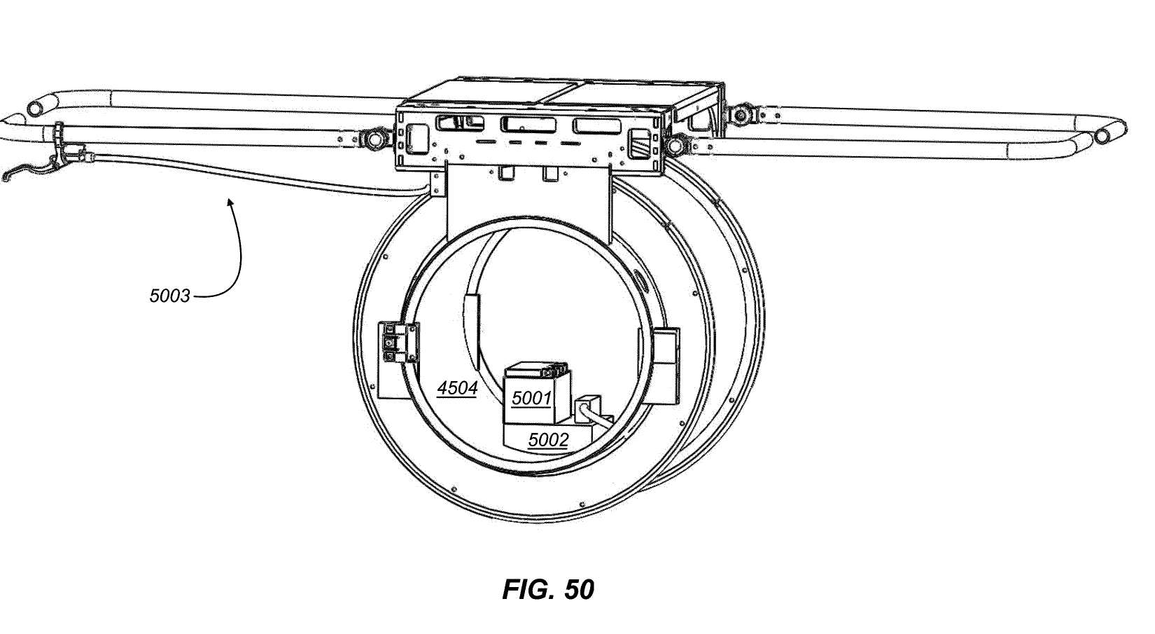

The embodiment of FIG. 50 includes the tabletop, handles, rollers, ball casters, and other components of Figs. A-B, and adds to that structure certain integral, internal operating machinery as now described. The container, 4504, includes sufficient room for certain kinds of operating machinery and power sources. Rollers (FIG. 45, 4510) can be powered conveyor rollers, operated by a power supply, 5001, and controller, 5002. The controller, 5002, can be operated by an operator from a fixed control (not shown) mounted to one of the handles, 4506, or from a handheld control in a wireless or mobile device (not shown). The power supply, 5001, can be replaceable batteries, rechargeable batteries, a fuel cell, or any other suitable source of electrical or mechanical power for the rollers. This arrangement can be used in any of the other embodiments described herein, suitably modified to accommodate the rollers (FIG. 45, 4510), the power supply, 5001, and controller, 5002, as well as any required fixed, wireless, or mobile control.

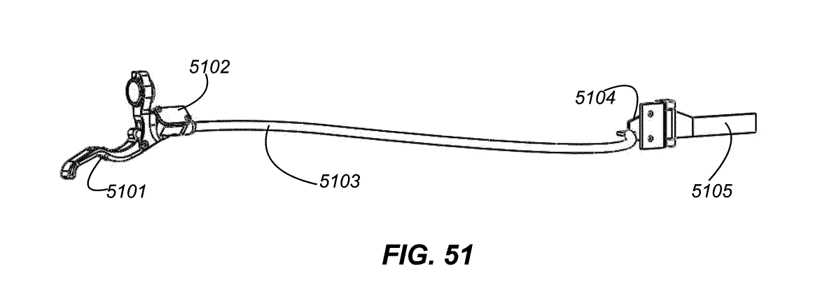

The brake system, 5003, of the embodiment of FIG. 50 is shown in greater detail in FIG. 51. The brake system includes a brake handle, 5101, mounted to one of the cart handles, 4506. The brake handle, 5101, when squeezed by an operator, operates a hydraulic master cylinder, 5102, to force hydraulic brake fluid through a brake line, 5103, into a hydraulic slave cylinder, 5104. The hydraulic slave cylinder, 5104, forces a brake paddle, brake spoon, or other braking device, 5105, against the flange or rim of the wheel, 4501, to slow or stop the cart, 4500.

The embodiment of 52 is similar to those of the earlier described FIGS. 45-51, but with certain variations to the wheel, 5201. The wheel, 5201, has the side flanges extended to form rims, 5202. The rims, 5202, may be adapted for road contact, either with or without a hard, semi-hard, elastomeric, or rubber road contact surface. In conjunction with the described rims, 5202, a tire is optional. When a tire is used, a thin, compressible tire is preferred. Any of the tire designs or materials as described elsewhere, herein, may be used as may be suitable for the embodiment employing a thin tire. As the tire passes over rough surfaces or terrain, it may be compressed to the point where one or both rims, 5202 contact the ground, helping stabilize the cart, 4501. In this type of application, rims with some resilient properties, but harder than the tire are advantageous to stabilizing the cart without producing high shock loads to the cart or its contents.

Alternatively, the rims, 5202 may be omitted, and the wheel textured, as shown, to form the road contact surface. The texturing to the wheel helps stabilize the cart when used on certain surfaces where a hard wheel is suitable, such as on loose or packed sand. Pebble texturing, 5203, as shown may be use, or other suitable textures such as diamond point texturing may be used.

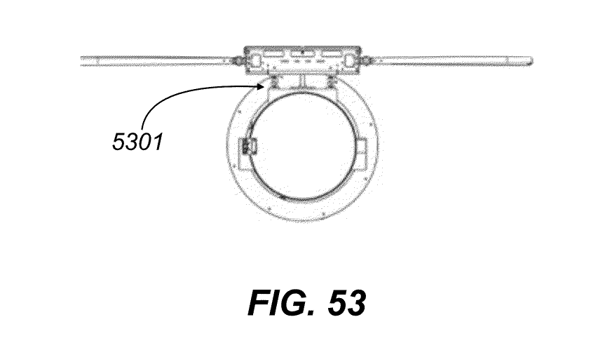

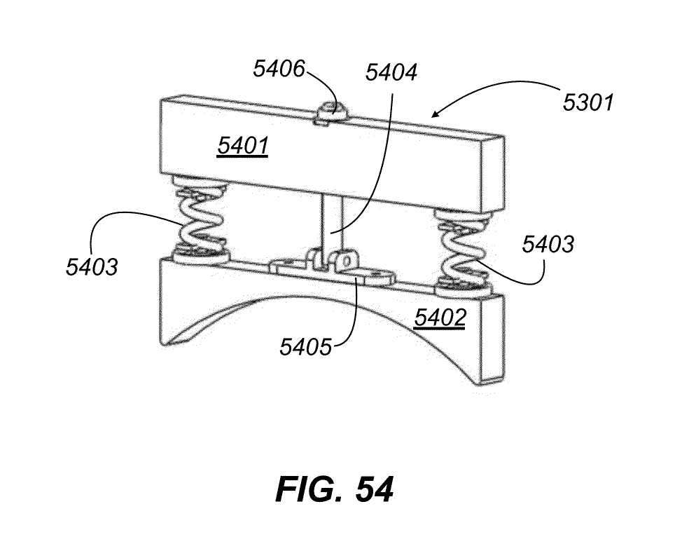

The embodiment of FIG. 53 shows an alternative suspension, 5301, for the tabletop and handle structures explained in detail above. This suspension is designed to absorb shocks produced by movement over rough terrain and the like not absorbed by the wheel and/or tire of the cart, so as to prevent those shocks from reaching an injured patient, sensitive equipment, or any other article or object carried atop the cart. The example suspension, 5301, is explained in detail in connection with FIGS. 54-58.

As seen in FIG. 54, the suspension, 5301, includes an upper block, 5401, connected to the tabletop structure or other platform atop the cart; a lower block, 5402, connected to the frame of the cart; and a pair of springs, 5403, connecting the blocks, 5401 and 5402, together. In addition, the movement of the blocks is controlled and constrained by pivoting guide rod, 5404, connected to the lower block, 5402, by pivot base, 5405. Guide rod, 5404, passes through a hole in upper block, 5401, and is capped by a nut or other retaining device, 5406, to keep guide rod, 5404, from pulling out of upper block, 5401, when the loading forces would otherwise permit such a separation of the blocks, 5401 and 5402.

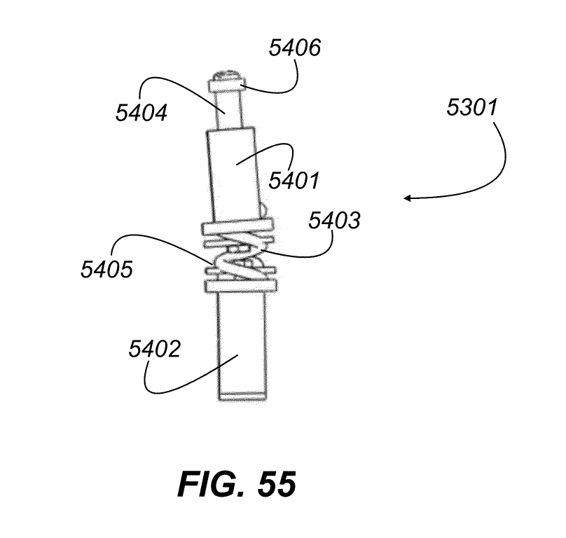

When a compressive load is applied to the suspension, 5301, it is able to absorb the load in the compression of the springs, and it is able to accommodate some sideways forces, as shown in FIG. 55. In FIG. 55, the guide rod, 5404, is seen to be sticking out of the top of upper block, 5401, due to compression of springs, 5403. Moreover, for example due to unevenly applied forces, upper block, 5401, is canted at a slight angle relative to lower block, 5402, which angle is accommodated by the pivot action of the guide rod, 5404.

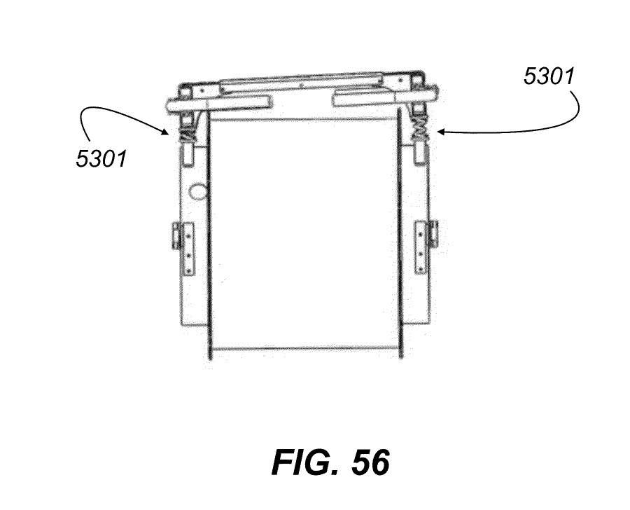

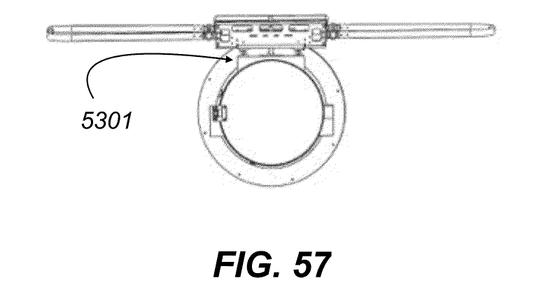

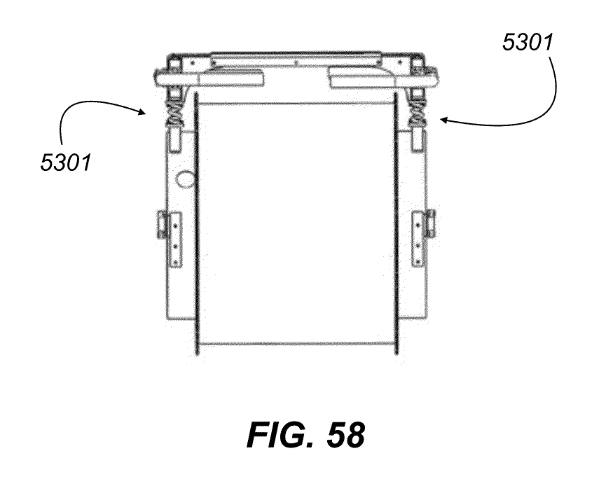

The end view of FIG. 56 and the side view of FIG. 57 shows the effect of such an uneven loading on a cart using two such suspensions, 5301. One suspension, 5301, compresses further than the other to absorb uneven loads from rough terrain, allowing the tabletop structure or other carrying platform to tilt momentarily, for example, rather than transmit the load directly to articles carried. When the load passes, the suspensions, 5301, relax into the positions shown in FIG. 58.

What is claimed is:

1. A rolling cart comprising:
a frame unit defining an interior space in which items are transportable;
a tire, the tire having a boundary defined by a circumference, a left edge maximum extent, and a right edge maximum extent, a distance between the left edge maximum extent and the right edge maximum extent sufficient to provide the cart with inherent lateral stability;
a handle supported from the frame, the cart moved and controlled by the handle; and
the interior space at least partly within the boundary.

2. The rolling cart of claim 1, further comprising:
a container in which the items are transportable suspended within the interior space, such that the tire rotates about the container without any corresponding rotation of the container.

3. The rolling cart of claim 2, wherein the container is integral to the frame unit.

4. The rolling cart of claim 1, further comprising:
a first plurality of rollers rotatably connected to the frame unit; and
a first inner surface defined by the wheel, the first inner surface contacting the first plurality of rollers for rotatable support.

5. The rolling cart of claim 1, further comprising:
at least a second plurality of rollers rotatably connected to the frame unit; and
a second inner surface defined by the wheel, the second inner surface contacting the second plurality of rollers for rotatable support.

6. The rolling cart of claim 1, further comprising:
handle mounts constructed and arranged to allow the handles to be removed;
a pole mount which can support the handle from the frame unit in a position substantially perpendicular to a plane in which the circumference lies; and
a shade fabric extensible from the handle; whereby
the handle, when supported by the pole mount, can support the shade fabric above a ground surface, and the shade fabric provides a sheltered area beneath the wheel when extended.

7. The rolling cart of claim 1, further comprising:
handle mounts constructed and arranged to allow the handles to be removed;
an oarlock mount which can support the handle from the frame unit when the cart lies in a position such that a plane in which the circumference lies is roughly parallel to a plane in which a water surface lies; and
a paddle end fitted to a distal end of the handle when the handle is supported by the oarlock mount; wherein
the cart possesses sufficient buoyancy to float along with the transportable items and a passenger.

8. The rolling cart of claim 1, wherein the tire substantially provides the sufficient buoyancy for the cart to float in any desired orientation.

9. The rolling cart of claim 1, further comprising a handle extension forward of the cart and a handle extension aft of the cart, whereby the cart can be maneuvered by two handlers, one fore and one aft.

10. The rolling cart of claim 1, wherein the further comprises:
a shoulder harness, whereby the cart can be hauled using shoulder contact to transfer force from a handler to the cart.

11. The rolling cart of claim 1, further comprising:
handle mounts constructed and arranged to allow the handles to be removed;
the handles further comprising:
folding sections, whereby the handles can be folded, removed, and stored in the interior space.

12. The rolling cart of claim 1, further comprising:
a flexible sheet suspended from the handle and configured and arranged to carry a non-ambulatory person or object.

13. The rolling cart of claim 1, further comprising:
a rigid litter suspended from the handle and configured and arranged to carry a non-ambulatory person or object.

14. The rolling cart of claim 1, the cart further comprising:
a medical stretcher support having hold-down points for securing a medical stretcher thereto.

15. The rolling cart of claim 1, the wheel further comprising:
an inflatable tire arranged within the circumference to support the cart.

16. The rolling cart of claim 15, usable in conjunction with a pump, the tire further comprising:
plural inflatable segments arranged within the circumference to support the cart;
an inflation fluid manifold constructed and arranged to communicate with the pump for communicating inflation fluid with the inflation fluid manifold;
plural bi-directional valves corresponding to the plural inflatable segments communicating inflation fluid between the inflation fluid manifold and the plural inflatable segments; the plural bi-directional valves constructed and arranged to substantially freely admit the inflation fluid from the manifold into an inflatable segment at a manifold pressure higher than a segment pressure, and to exhaust inflation fluid from the inflatable segment into the manifold only at a segment pressure higher than a manifold pressure by at least an increment provided by a combination of a load of the cart and action of the bi-directional pump communicating inflation fluid out of the inflation fluid manifold.

17. The cart of claim 16, wherein the plural bi-directional valves are reed valves further comprising:
a valve body having a passage defined through the valve body between the inflation fluid manifold and the inflatable segment, the passage having an edge;
a reed affixed to the edge of the passage, having one surface toward the inflation fluid manifold and another surface toward the inflatable segment, and bendable toward the inflation fluid manifold or the inflatable segment through the passage; and
a spring disposed substantially adjacent to one surface of the reed such that a higher pressure is required to bend the reed toward the inflation fluid manifold than toward the inflatable segment.

18. The rolling cart of claim 1, usable in conjunction with a pump, the wheel further comprising:
plural inflatable segments arranged within the circumference to support the cart.

19. The rolling cart of claim 18, further comprising:
an inflation fluid manifold constructed and arranged to communicate with the pump for communicating inflation fluid with the inflation fluid manifold;
plural bi-directional valves corresponding to the plural inflatable segments manually selectable to communicate inflation fluid between the inflation fluid manifold and each one or more of the plural inflatable segments.

20. A wheeled cart, comprising:
a central cargo container; and
only one tire, circumferentially disposed about the central cargo container, from which the central cargo container is suspended; wherein
the one tire has a width sufficient to keep a center of gravity of the cart between edges of a ground contact region of the tire.

21. The wheeled cart of claim 20, further comprising:
a rigid carrying platform including a handle attached to the central cargo container.

22. The wheeled cart of claim 21, wherein the rigid platform is a medical litter.

23. The wheeled cart of claim 20, wherein the tire is one of plural interchangeable tires, each used independently from one another.

24. The wheeled cart of claim 20, further comprising:
articulated sections with locking joints forming the handle, the articulated joints configurable to at least a moving position and a stand position, wherein the cart is stable without an operator holding it in place when the articulated joints are configured to the stand position.

25. The wheeled cart of claim 24, further comprising:
the handle comprising a frame to which a platform can be attached; and
at least one articulated joint comprising a fold-up stand section.

26. A wheeled cart, comprising:
a central cargo container;
a handle attached to the central cargo container; and
two tires, circumferentially disposed about the central cargo container, from which the central cargo container is suspended; wherein
the two tires being separated by a width sufficient to keep a center of gravity of the cart between edges of a ground contact region of the two tires.

27. The wheeled cart of claim 26, further comprising:
articulated sections with locking joints forming the handle, the articulated joints configurable to at least a moving position and a stand position, wherein the cart is stable without an operator holding it in place when the articulated joints are configured to the stand position.

28. The wheeled cart of claim 27, further comprising:
the handle comprising a frame to which a platform can be attached; and
at least one articulated joint comprising a fold-up stand section.

29. A wheeled cart, comprising:
a wheel, the wheel having a boundary defined by an inner circumference, an outer circumference, a left edge maximum extent, and a right edge maximum extent, a distance between the left edge maximum extent and the right edge maximum extent sufficient to provide the cart with inherent lateral stability;
a frame unit defining an interior space circumscribed by the inner circumference, in which items are transportable;
a handle supported from the frame, the cart moved and controlled by the handle; and
at least three rollers affixed to the frame unit at positions such that a circumscribing circle tangential to the at least three rollers is smaller than the inner circumference of the wheel.

30. The cart of claim 29, further comprising:
first and second pluralities of ball casters, each plurality affixed to one side of the frame;
the wheel further including plural flange surfaces, each disposed in opposition to the ball casters on each side of the frame, such that the ball casters act as thrust bearings to maintain the frame within the inner circumference of the wheel; wherein
the distance between the plural flange surfaces is sufficient that placing the first plurality of ball casters in contact with one of the plural flange surfaces keeps the second plurality of ball casters out of contact with another of the plural flange surfaces.

31. The cart of claim 29, the frame unit further comprising:
a rigid, removable tabletop surface having plural locking hinges affixed thereto; wherein
the handles are supported from the frame by the plural locking hinges affixed to the tabletop surface.

32. The cart of claim 30, wherein the wheel further comprises:
plural flanges defining rims for contacting the ground.

33. The cart of claim 32, wherein the wheel further comprises:
a resilient tire slightly extending past the rims for contacting a ground surface, such that when compressed by rolling over the ground surface the rims may additionally contact the ground surface to assist with supporting the cart.

34. The cart of claim 30, wherein the wheel further comprises:
a textured surface for providing additional traction on granular surfaces.

35. The cart of claim 29, further comprising:
a traction motor built into at least one of the at least three rollers; and
a self-contained power supply and control unit in the interior space.

36. The cart of claim 35, wherein the power supply includes a battery.

37. The cart of claim 35, wherein the power supply includes a fuel cell.

38. The cart of claim 35, wherein the control unit is operated from a control panel affixed to one of the plurality of handles.

39. The cart of claim 35, wherein the control unit is operated from a handheld controller.

40. A rolling cart comprising:
a frame unit defining an interior space in which items are transportable;
a tire, the tire having a boundary defined by a circumference, a left edge maximum extent, and a right edge maximum extent, a distance between the left edge maximum extent and the right edge maximum extent sufficient to provide the cart with inherent lateral stability; and
the interior space at least partly within the boundary.

41. The rolling cart of claim 40, further comprising:
a rigid platform including a handle by which the cart can be moved and controlled.

42. The rolling cart of claim 41, wherein the rigid platform is configured and arranged to carry a non-ambulatory person or object.

43. The rolling cart of claim 42, wherein the rigid platform is a medical litter.

44. A wheeled cart, comprising:
a central cargo container; and
only one tire, circumferentially disposed about the central cargo container, from which the central cargo container is suspended;
a rigid carrying platform including a handle, suspended from the central cargo container by a pivoting spring suspension system; wherein
the one tire has a width sufficient to keep a center of gravity of the cart between edges of a ground contact region of the tire.
